(19) United States
(12) Patent Application Publication
(10) Pub. No.: US 2025/0263514 A1
(43) Pub. Date: Aug. 21, 2025

(54) Process for Preparing SVHC-Free Phenolic Resins

(71) Applicant: SI Group, Inc., The Woodlands, TX (US)

(72) Inventors: Kelly S. Chichak, Halfmoon, NY (US); Nancy Winchester, Humble, TX (US); Darren C. Seel, Amsterdam, NY (US); Long Zhang, Spring, TX (US)

(21) Appl. No.: 19/056,437

(22) Filed: Feb. 18, 2025

Related U.S. Application Data
(60) Provisional application No. 63/662,653, filed on Jun. 21, 2024.
(60) Provisional application No. 63/643,747, filed on May 7, 2024.
(60) Provisional application No. 63/554,510, filed on Feb. 16, 2024.

(51) Int. Cl. C08G 8/24; B60C 1/00; C08K 3/36; C08L 7/00; C08L 9/00

(52) U.S. Cl. CPC C08G 8/24; C08K 3/36; C08L 7/00; C08L 9/00; B60C 1/0008; B60C 1/0016; B60C 1/0025; B60C 2001/005; C08G 2380/00; C08L 2205/03

(57) ABSTRACT

The present disclosure is directed to a novolac resin and a process for preparing a novolac resin including a low concentration of substances of very high concern. The novolac resin is formed from an alkylphenol composition including one or more alkylphenol monomers, one or more phenolic monomers, and an aldehyde and/or a ketone. The novolac resin exhibits desired tack performance, which can be beneficial for rubber applications.

### CROSS-REFERENCE TO RELATED APPLICATIONS

The present application claims filing benefit of U.S. Provisional Patent Application No. 63/554,510 having a filing date of Feb. 16, 2024, U.S. Provisional Patent Application No. 63/643,747 having a filing date of May 7, 2024, and U.S. Provisional Patent Application No. 63/662,653 having a filing date of Jun. 21, 2024, which are hereby incorporated by reference in their entirety.

### BACKGROUND

Rubber products can be made from natural rubber, synthetic rubber, or blends thereof. In certain instances, these rubber products can be made of several rubber layers, each with the same or different chemical composition. During manufacture, it may be desirable for a respective layer to adhere to one or more adjacent layers, particularly when in a pre-vulcanized state. In this regard, it may be desired for a rubber or rubber mixture to have a particular tack—which may generally be defined as a force required to pull apart two rubber layers or rubber mixtures (e.g., pre-vulcanized rubber or rubber mixtures) which have been pressed together under certain defined conditions. While natural rubber mixtures may generally have good tackiness, mixtures of synthetic rubbers may be less tacky or possess no tackiness at all. As a result, a tackifier may be added to the rubber or rubber mixture to increase the tack.

Novolac resins may be used as tackifiers in a large variety of rubber compositions. Generally, these resins have a repeating structure of phenolic units obtained by reacting phenolic compounds with aldehydes in the presence of an acid catalyst. Differing in chemical structure, a variety of phenolic novolac resins have been combined with rubber formulations as tackifier resins.

However, in recent years, there have been growing concerns about the potential adverse impact from certain phenolic compounds on human health and the environment. Regulations in certain regions have started to identify certain phenolic compounds as candidates for “substances of very high concern” (SVHC), particularly when used at high levels. Therefore, it can be costly and cumbersome for companies that make such rubber products, such as tire manufacturers, to comply with these tightening regulations.

Consequently, there remains a need to develop an alternative method and/or a novolac resin that can be substantially free of SVHC, while still providing sufficient tackiness and mechanical strength when used in a rubber composition.

### SUMMARY

In accordance with one embodiment of the present disclosure, a process for preparing a novolac resin is disclosed. The process comprises: reacting an alkylphenol composition comprising one or more alkylphenol monomers, each of the one or more alkylphenol monomers having one or more alkyl groups of at least 12 carbon atoms, and one or more phenolic monomers having the following structure (IV)

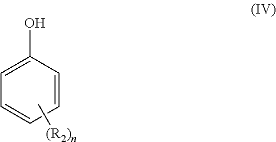

wherein R₂ is a C₁₋₄ alkyl and n is 0, 1, or 2 with an aldehyde and/or a ketone. The novolac resin contains 1 wt. % or less of a phenolic compound that is a substance of very high concern based on the weight of the novolac resin.

In accordance with another embodiment of the present disclosure, a novolac resin is disclosed. The novolac resin is prepared by a process comprising: reacting an alkylphenol composition comprising one or more alkylphenol monomers, each having one or more alkyl groups of at least 12 carbon atoms, and one or more phenolic monomers having the following structure (IV)

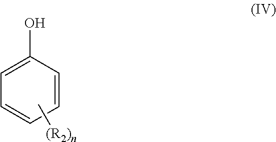

wherein R₂ is a C₁₋₄ alkyl and n is 0, 1, or 2 with an aldehyde and/or a ketone. The novolac resin contains 1 wt. % or less of a phenolic compound that is a substance of very high concern based on the weight of the novolac resin.

In accordance with another embodiment of the present disclosure, a rubber composition is disclosed. The rubber composition comprises the aforementioned novolac resin and a natural rubber, a synthetic rubber, or a mixture thereof.

In accordance with another embodiment of the present disclosure, a one-pot process for preparing a novolac resin is disclosed. The process comprises: alkylating phenol with one or more olefins to form one or more alkylphenol monomers having an alkyl group of at least 12 carbon atoms, wherein the molar ratio of the phenol to the one or more olefins is 1 or more; providing an alkylphenol composition comprising the one or more alkylphenol monomers having an alkyl group of at least 12 carbon atoms, and one or more phenolic monomers having the following structure (IV)

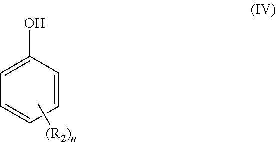

wherein R₂ is a C₁₋₄ alkyl and n is 0, 1, or 2; and reacting the alkylphenol composition with an aldehyde and/or a ketone to form a novolac resin. The alkylating and reacting steps are carried out in one reactor. The novolac resin contains 1 wt. % or less of a phenolic compound that is a substance of very high concern based on the weight of the novolac resin.

In accordance with another embodiment of the present disclosure, a novolac resin is disclosed. The novolac resin is prepared by a process comprising: alkylating phenol with one or more olefins, wherein the molar ratio of the phenol to the one or more olefins is 1 or more, to form one or more alkylphenol monomers having an alkyl group of at least 12 carbon atoms; providing an alkylphenol composition comprising the one or more alkylphenol monomers having an alkyl group of at least 12 carbon atoms, and one or more phenolic monomers having the following structure (IV)

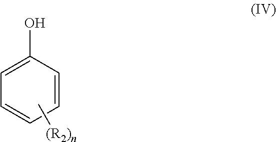

wherein R₂ is a C₁₋₄ alkyl and n is 0, 1, or 2; and reacting the alkylphenol composition with an aldehyde and/or a ketone to form a novolac resin. The alkylating and reacting steps are carried out in one reactor. The novolac resin contains 1 wt. % or less of a phenolic compound that is a substance of very high concern based on the weight of the novolac resin.

In accordance with another embodiment of the present disclosure, a rubber composition is disclosed. The rubber composition comprises the aforementioned novolac resin and a natural rubber, a synthetic rubber, or a mixture thereof.

### BRIEF DESCRIPTION OF THE DRAWINGS

FIGS. 1A-1D illustrate the tack performance of various tackifiers in rubber compositions and rubber products as described in Example 2.

FIG. 2 illustrates the tack performance based on the loading level of a novolac resin as described in Example 2.

FIGS. 3A-3B illustrate the unaged tack performance of a novolac resin as disclosed herein as a function of the alkyl chain length of the alkylphenol monomer as described in Example 3.

FIG. 4 illustrates the unaged tack performance of a novolac resin as described in Example 4.

FIGS. 5A-5B illustrate reaction pathways as described in Example 5 for preparing a novolac resin as described herein.

FIG. 6 illustrates the response surface for the reflux process of sample numbers 5-13 of Example 6.

FIG. 7 illustrates the response surface for the energetic process of sample numbers 31-44 of Example 6.

FIG. 8 illustrates the tack response of the samples made according to the energetic process disclosed and tested in the application performance testing of Example 11.

FIG. 9 illustrates the tack performance of the samples made according to the energetic process disclosed and tested in the application performance testing of Example 12.

### DEFINITIONS

It is to be understood that the terminology used herein is for the purpose of describing particular embodiments only and is not intended to limit the scope of the present disclosure unless expressly defined herein.

“About” means within 5% of the disclosed value.

“Alkyl” refers to straight chain, branched chain, or cyclic monovalent saturated aliphatic hydrocarbyl groups and “C_{q}-Cᵣ alkyl” refers to alkyl groups having from q to r carbon atoms. This term includes, by way of example, straight chain, branched chain, or cyclic hydrocarbyl groups, such as methyl, ethyl, propyl, butyl, pentyl, hexyl, heptyl, octyl, nonyl, decyl, undecyl, dodecyl, tridecyl, tetradecyl, pentadecyl, hexadecyl, heptadecyl, octadecyl, nonadecyl, icosanyl, henicosanyl, docosanyl, tricosanyl, tetracosanyl, pentacosanyl, hexacosanyl, heptacosanyl, octacosanyl, and the like.

“Amino” refers to the group NH₂.

“Aryl” refers to a 5- or 6-membered aromatic ring, for example phenyl, or a 7 to 12 membered bicyclic ring system where at least one of the rings is aromatic, for example naphthyl. An aryl group may be optionally substituted by one or more substituents, for example up to 4, 3 or 2 substituents. Preferably the aryl group is phenyl.

“Carboxyl” or “carboxy” refers to —COOH or salts thereof.

“Halo” or “halogen” refers to a fluorine (fluoro, F), chlorine (chloro, CI), bromine (bromo, Br) or iodine (iodo, I).

### DETAILED DESCRIPTION

It is to be understood by one of ordinary skill in the art that the present discussion is a description of exemplary embodiments only and is not intended as limiting the broader aspects of the present disclosure.

In general, the present disclosure is directed to a novolac resin and a method of preparing the same. In particular, the present inventors have discovered a method that can provide a number of benefits to the overall manufacturing process. In addition, the present inventors have discovered a resulting novolac resin that may also exhibit a number of benefits.

For instance, the present inventors have discovered that utilizing the method as disclosed herein can provide a novolac resin with a relatively low amount of substances of very high concern (also referred to as SVHCs). According to the European Chemicals Agency (ECHA), “substances that may have serious and often irreversible effects on human health and the environment can be identified as substances of very high concern (SVHCs)” (see https://echa.europa.eu/substances-of-very-high-concern-identification). Under the European Union's Registration, Evaluation, Authorisation and Restriction of Chemicals (REACH) regulation, a list of SVHCs has been identified and authorized (see https://echa.europa.eu/authorisation-list) and a candidate list of SVHCs has been identified (see https://echa.europa.eu/candidate-list-table).

In certain embodiments, phenolic compounds (e.g., certain alkylphenol monomers and/or phenolic monomers) that are endocrine disrupters may have a high probability of being identified as a SVHC, due to their adverse impact on health and the environment. For an alkylphenol monomer, its ability to adversely disrupt human and animal endocrine systems depends on a few factors, including the length and branching of the alkyl group of the alkylphenol monomer. Typically, an alkylphenol monomer having a C₃-C₁₂, such as a C₄-C₁₀, alkyl group with branching tends to have a stronger endocrine disruption. See Boutledge, et al. “Structural features of alkylphenolic chemicals associated with estrogenic activity,” The Journal of Biological Chemistry 272(6): 3280-88 (1997), which is incorporated herein by reference in its entirety.

Furthermore, in one embodiment, the SVHC may be a monomer input (e.g., alkylphenol monomer, phenolic monomer as defined herein) input into the process of preparing a novolac resin as described herein. During such process, however, the monomer input may be consumed during the reaction such that the resulting novolac resin is substantially free of the monomer.

In this regard, in certain embodiments, the SVHC may include C₃-C₁₂ alkyl substituted phenols, such as C₄-C₁₂ alkyl substituted phenols, such as C₄-C₁₀ alkyl substituted phenols. In certain embodiments, such alkyl substitution may be para-substituted. In certain embodiments, such alkyl substitution may be branched. In some embodiments, such alkyl substitution may be branched and at the para-position.

Thus, in some embodiments, the process and/or the novolac resin is substantially free of a phenolic compound (e.g., alkylphenol monomer, phenolic monomer as defined herein) (that may be a SVHC), that is an alkylphenol monomer having a branched alkyl group. In some embodiments, the process and/or the novolac resin is substantially free of a phenolic compound (e.g., alkylphenol monomer, phenolic monomer as defined herein) (that may be a SVHC), that is an alkylphenol monomer having an alkyl group substituted at the para position. In some embodiments, the process and/or the novolac resin is substantially free of a phenolic compound (e.g., alkylphenol monomer, phenolic monomer as defined herein) (that may be a SVHC), that is an alkylphenol monomer having a branched alkyl group substituted at the para position. For example, this may include a para-substituted, tertiary alkylphenol.

In some embodiments, the process and/or the resulting novolac resin is substantially free of a phenolic compound (e.g., alkylphenol monomer, phenolic monomer as defined herein) (that may be a SVHC) that is a C₂-C₁₈ alkylphenol, such as a C₃-C₁₆ alkylphenol, such as a C₃-C₁₂ alkylphenol, such as a C₄-C₁₂ alkylphenol, such as a C₄-C₁₀ alkylphenol, such as a C₄-C₉ alkylphenol. In some embodiments, the alkyl of the aforementioned alkylphenol may be at the para-position. In some embodiments, the alkyl of the aforementioned alkylphenol may be branched. In some embodiments, the alkyl of the aforementioned alkylphenol may be at the para-position and branched. Further, regarding the aforementioned, in one embodiment, the process may be substantially free of the phenolic compound (e.g., alkylphenol monomer, phenolic monomer as defined herein) (that may be a SVHC). In another embodiment, the novolac resin may be substantially free of the phenolic compound (e.g., alkylphenol monomer, phenolic monomer as defined herein) (that may be a SVHC).

The substances of very high concern may be present in an amount of about 1 wt. % or less, such as about 0.9 wt. % or less, such as about 0.8 wt. % or less, such as about 0.7 wt. % or less, such as about 0.6 wt. % or less, such as about 0.5 wt. % or less, such as about 0.4 wt. % or less, such as about 0.3 wt. % or less, such as about 0.2 wt. % or less, such as about 0.1 wt. % or less, such as about 0.05 wt. % or less, such as about 0.01 wt. % or less, such as about 0 wt. %. The substances of very high concern may be present in an amount of 0 wt. % or more, such as more than 0 wt. %, such as about 0.001 wt. % or more, such as about 0.005 wt. % or more, such as about 0.01 wt. % or more, such as about 0.03 wt. % or more, such as about 0.05 wt. % or more, such as about 0.08 wt. % or more, such as about 0.1 wt. % or more, such as about 0.2 wt. % or more, such as about 0.3 wt. % or more, such as about 0.4 wt. % or more, such as about 0.5 wt. % or more. The about 0 wt. % may be a non-detectable amount by GC, LC, or other commonly known measurement method. In one embodiment, the aforementioned weight percentages may be based on the weight of the novolac resin. Further, in one embodiment, the aforementioned weight percentages may be based on the weight of the alkylphenol composition as defined herein. In another embodiment, the aforementioned weight percentages may be based on the weight of the one or more alkylphenol monomers as defined herein. In a further embodiment, the aforementioned weight percentages may be based on the weight of the one or more phenolic monomers as defined herein.

Similarly, the method as disclosed herein may also allow for a novolac resin having a relatively low monomer concentration of the one or more alkylphenol monomers as defined herein. For instance, the one or more alkylphenol monomers may be present in an amount of about 4 wt. % or less, such as about 3.5 wt. % or less, such as about 3 wt. % or less, such as about 2.5 wt. % or less, such as about 2 wt. % or less, such as about 1.8 wt. % or less, such as about 1.6 wt. % or less, such as about 1.4 wt. % or less, such as about 1.2 wt. % or less, such as about 1 wt. % or less, such as about 0.9 wt. % or less, such as about 0.8 wt. % or less, such as about 0.7 wt. % or less, such as about 0.6 wt. % or less, such as about 0.5 wt. % or less, such as about 0.4 wt. % or less, such as about 0.3 wt. % or less, such as about 0.2 wt. % or less, such as about 0.1 wt. % or less. In addition, the one or more alkylphenol monomers may be present in an amount of 0 wt. % or more, such as more than 0 wt. %, such as about 0.001 wt. % or more, such as about 0.005 wt. % or more, such as about 0.01 wt. % or more, such as about 0.03 wt. % or more, such as about 0.05 wt. % or more, such as about 0.08 wt. % or more, such as about 0.1 wt. % or more, such as about 0.2 wt. % or more, such as about 0.3 wt. % or more, such as about 0.4 wt. % or more, such as about 0.5 wt. % or more. In one embodiment, the aforementioned weight percentages may be based on the weight of the novolac resin.

Also, the method as disclosed herein may also allow for a novolac resin having a relatively low monomer concentration of the one or more phenolic monomers as defined herein. For instance, the one or more phenolic monomers may be present in an amount of about 4 wt. % or less, such as about 3.5 wt. % or less, such as about 3 wt. % or less, such as about 2.5 wt. % or less, such as about 2 wt. % or less, such as about 1.8 wt. % or less, such as about 1.6 wt. % or less, such as about 1.4 wt. % or less, such as about 1.2 wt. % or less, such as about 1 wt. % or less, such as about 0.9 wt. % or less, such as about 0.8 wt. % or less, such as about 0.7 wt. % or less, such as about 0.6 wt. % or less, such as about 0.5 wt. % or less, such as about 0.4 wt. % or less, such as about 0.3 wt. % or less, such as about 0.2 wt. % or less, such as about 0.1 wt. % or less. In addition, the one or more phenolic monomers may be present in an amount of 0 wt. % or more, such as more than 0 wt. %, such as about 0.001 wt. % or more, such as about 0.005 wt. % or more, such as about 0.01 wt. % or more, such as about 0.03 wt. % or more, such as about 0.05 wt. % or more, such as about 0.08 wt. % or more, such as about 0.1 wt. % or more, such as about 0.2 wt. % or more, such as about 0.3 wt. % or more, such as about 0.4 wt. % or more, such as about 0.5 wt. % or more. In one embodiment, the aforementioned weight percentages may be based on the weight of the novolac resin.

Furthermore, the present inventors have discovered a novolac resin that may be able to provide a desired tack for particular applications, such as for rubber applications. Without the SVHCs, as indicated above, the novolac resin as described herein may provide the desired tack performance. In general, the improvement in aged tack (or tack retention) of a tackifying resin or rubber composition can be particularly desirable, as it is often required that a tackifier resin remain sufficiently tacky over a fairly long period of time.

In this regard, in some embodiments, the tack performance or tack retention may increase by 10% or more, such as 20% or more, such as 30% or more, such as 40% or more, such as 50% or more, such as 60% or more, such as 70% or more when comparing a rubber composition with a phenolic resin prepared from a SVHC phenolic compound, such as para-tert-butylphenol (PTBP), para-tert-octylphenol (PTOP), para-nonylphenol (PNP) (branched and linear), and/or para-dodecylphenol (PDDP), to the novolac resin as described herein.

Similarly, the hysteresis increase may be reduced by 5% or more when comparing to a rubber composition with a phenolic resin prepared from a SVHC phenolic compound, such as para-tert-butylphenol (PTBP), para-tert-octylphenol (PTOP), para-nonylphenol (PNP) (branched and linear), and/or para-dodecylphenol (PDDP), to the novolac resin as described herein.

### Method of Preparing Novolac Resin

Generally, the method includes reacting an alkylphenol composition as defined herein with one or more aldehyde and/or ketones. For instance, such aldehyde and/or ketone may react with one or more monomers of the alkylphenol composition to form the novolac resin. In addition, the alkylphenol composition may comprise one or more alkylphenol monomers and one or more phenolic monomers as described below.

### Alkylphenol Composition

As indicated above, the method utilizes an alkylphenol composition. The alkylphenol composition comprises one or more alkylphenol monomers having one or more alkyl groups of at least 12 carbon atoms. The alkylphenol composition may also comprise one or more phenolic monomers as disclosed herein.

In forming the novolac resin as disclosed herein and as indicated above, the method utilizes one or more alkylphenol monomers. In one embodiment, a respective alkylphenol monomer of the one or more alkylphenol monomers may have one alkyl group. In general, such an alkylphenol monomer may be referred to as a monoalkylphenol. In a further embodiment, all of the one or more one or more alkylphenol monomers may have one alkyl group. In another embodiment, at least one respective alkylphenol monomer of the one or more alkylphenol monomers may have two alkyl groups. In general, such an alkylphenol monomer may be referred to as a dialkylphenol. In this regard, in one embodiment, one or more alkylphenol monomers may include one or more monoalkylphenol monomers having an alkyl group of at least 12 carbon atoms and one or more dialkylphenol monomers having alkyl groups of at least 12 carbon atoms.

The monoalkylphenol monomers may constitute 50 wt. % or more, such as 55 wt. % or more, such as 60 wt. % or more, such as 65 wt. % or more, such as 70 wt. % or more, such as 75 wt. % or more, such as 80 wt. % or more, such as 85 wt. % or more, such as 90 wt. % or more, such as 95 wt. % or more, such as 98 wt. % or more, such as 99 wt. % or more of the one or more alkylphenol monomers. The monoalkylphenol monomers may constitute 50 mol % or more, such as 55 mol % or more, such as 60 mol % or more, such as 65 mol % or more, such as 70 mol % or more, such as 75 mol % or more, such as 80 mol % or more, such as 85 mol % or more, such as 90 mol % or more, such as 95 mol % or more, such as 98 mol % or more, such as 99 mol % or more of the one or more alkylphenol monomers. The dialkyl monomers may constitute 25 wt. % or less, such as 20 wt. % or less, such as 15 wt. % or less, such as 10 wt. % or less, such as 5 wt. % or less of the one or more alkylphenol monomers. The dialkyl monomers may constitute 25 mol % or less, such as 20 mol % or less, such as 15 mol % or less, such as 10 mol % or less, such as 5 mol % or less of the one or more alkylphenol monomers.

In general, the alkyl substitution on the benzene of the one or more alkylphenol monomers may be at the ortho, meta, and/or para positions. In one embodiment, the alkyl substitution may be at the ortho position. In a further embodiment, the alkyl substitution may be at the meta position. In another embodiment, the alkyl substitution may be at the para position.

In certain embodiments, the alkylphenol monomer may include at least two alkyl groups. In this regard, such alkyl groups may be at the ortho position and the meta position in one embodiment.

In general, it is known in the art that the phenyl ring of phenols may be derivatized with aldehydes and/or ketones only by reactions at the ortho- and/or para-positions to the hydroxyl group. In this regard, the meta-position on the phenyl ring may not be reactive. In the preparation of novolac resins, polymerization may occur at the two ortho-positions and one para-position. The novolac resin may be prepared from one or more phenols having one alkyl substituent in one ortho- or in the para-position to the hydroxyl group. In one particular embodiment, the novolac resin may be prepared from one or more phenols having one alkyl substituent in the para-position to the hydroxyl group.

With one alkyl substitution, this may leave only two ring positions, either two ortho-positions (para-alkyl substitution) or one ortho-position and one para-position (ortho-alkyl substitution), available for polymerization. With the ortho-positions open, the resulting novolac resin then may be a “linear” resin. In this regard, linear novolac resins to be used may be prepared from ortho-alkylphenols, para-alkylphenols, or a mixture of ortho-alkylphenols and para-alkylphenols. In one embodiment, linear novolac resins may be prepared from para-alkylphenols.

In one embodiment, the one or more alkylphenol monomers may have the following structural formula (I) wherein the alkyl substitution is at the para position:

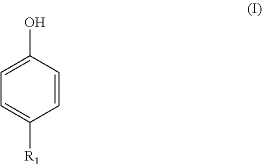

wherein
R₁ is an optionally substituted alkyl group having at least 12 to 100 carbon atoms.

As indicated above, the one or more alkylphenol monomers have one or more alkyl groups of at least 12 carbon atoms. In this regard, the alkyl groups, such as R₁, have at least 12 carbon atoms, such as at least 14 carbon atoms, such as at least 16 carbon atoms, such as at least 18 carbon atoms, such as at least 19 carbon atoms, such as at least 20 carbon atoms, such as at least 24 carbon atoms, such as at least 28 carbon atoms, such as at least 30 carbon atoms, such as at least 34 carbon atoms, such as at least 36 carbon atoms, such as at least 40 carbon atoms, such as at least 44 carbon atoms, such as at least 48 carbon atoms, such as at least 50 carbon atoms. The alkyl groups, such as R₁, may have 100 carbon atoms or less, such as 90 carbon atoms or less, such as 80 carbon atoms or less, such as 70 carbon atoms or less, such as 60 carbon atoms or less, such as 50 carbon atoms or less, such as 46 carbon atoms or less, such as 42 carbon atoms or less, such as 38 carbon atoms or less, such as 34 carbon atoms or less, such as 30 carbon atoms or less, such as 26 carbon atoms or less, such as 22 carbon atoms or less, such as 20 carbon atoms or less.

As general examples, the number of carbon atoms in the alkyl group may be from 12 to 100 carbon atoms, such as from 16 to 100 carbon atoms, such as from 19 to 100 carbon atoms, such as from 19 to 50 carbon atoms, such as from 19 to 40 carbon atoms, such as from 19 to 30 carbon atoms, such as from 20 to 30 carbon atoms, such as such as from 20 to 24 carbon atoms or from 24 to 28 carbon atoms, such as from 26 to 28 carbon atoms.

Further, in one embodiment, R₁ may be unsubstituted. In another embodiment, R₁ may be substituted. For instance, the alkyl group may be substituted with a substituent group. The substituent group may include, but is not limited to, an aryl group, a hydroxyl group, an amino group, a carboxyl group, a halogen, a thiol group, a disulfide group, etc., or a combination thereof. In addition, more than one of the aforementioned substituent groups may be utilized. In one embodiment, the substituent group or substitution may be an aryl group. For instance, the aryl group may be a phenyl group. The substituent group should generally not impair the tackifying properties of the novolac resin and/or the resulting application (e.g., rubber composition). In general, the substituent group may be provided to add beneficial properties to the novolac resin for manufacturing purposes, for increased tack, and/or for improving the properties for a general application (e.g., of a rubber composition to which it is added).

Further, the alkyl group of R₁ may be linear, branched, or cyclic. In one embodiment, R₁ may be linear. In another embodiment, R₁ may be branched. In a further embodiment, R₁ may be cyclic.

The one or more alkylphenol monomers may include a mixture of alkylphenol monomers in one embodiment. In this regard, the one or more alkylphenol monomers may include any combination of at least a first alkylphenol monomer, a second alkylphenol monomer, a third alkylphenol monomer, and/or a fourth alkylphenol monomer.

For instance, they may include a mixture of alkylphenol monomers satisfying the structure for formula (I) wherein R₁ may be different in each alkylphenol monomer. For instance, each R₁ may have a different length and/or configuration (e.g., linear vs. branched). Such a mixture of alkylphenol monomers may be utilized in forming the novolac resin disclosed herein. Accordingly, the resulting novolac resin disclosed herein having an alkyl group may have some variation within the R₁ group within a particular novolac resin.

In one embodiment, the one or more alkylphenol monomers are a mixture of alkylphenol monomers having one or more alkyl groups (e.g., linear alkyls) with varying length, with the major components having one or more alkyl groups from 20 to 30 carbon atoms, such as from 20 to 24 carbon atoms or 24 to 28 carbon atoms, such as from 26 to 30 carbon atoms. In one embodiment, the one or more alkylphenol monomers include a C₂₄-C₂₈ alkylphenol monomer or a mixture containing two or more of such alkylphenol monomers.

Examples of alkylphenol monomers include, but are not limited to, dodecylphenol, tetradecylphenol, hexadecylphenol, octadecylphenol, docosanylphenol, tetracosanylphenol, pentacosanylphenol, hexacosanylphenol, heptacosanylphenol, octacosanylphenol, etc., as well as mixtures thereof. In one embodiment, the alkylphenol monomers may include docosanylphenol, tetracosanylphenol, pentacosanylphenol, hexacosanylphenol, heptacosanylphenol, octacosanylphenol, or a mixture thereof. In one embodiment, the alkylphenol monomers may include tetracosanylphenol, pentacosanylphenol, hexacosanylphenol, heptacosanylphenol, octacosanylphenol, or a mixture thereof.

In addition to structural formula (I) above, it should be understood that the one or more alkylphenol monomers may also further include alkylphenol monomers of structural formulae (II) and/or (Ill) in certain embodiments:

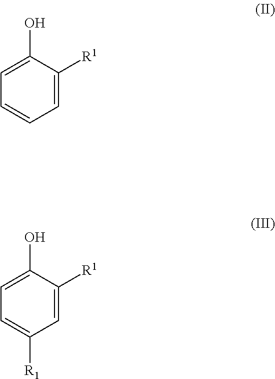

wherein
   R₁ is as defined above.

In one embodiment, the one or more alkylphenol monomers may also include the alkylphenol monomer of structural formula (11). In another embodiment, the one or more alkylphenol monomers may also include the alkylphenol monomer structural formula (111). In a further embodiment, the one or more alkylphenol monomers may also include the alkylphenol monomers of structural formulae (II) and (111).

In one embodiment, the one or more alkylphenol monomers may be provided in an amount of 5 mol % or more, such as 10 mol % or more, such as 15 mol % or more, such as 20 mol % or more, such as 25 mol % or more, such as 30 mol % or more, such as 35 mol % or more, such as 40 mol % or more, such as 45 mol % or more, such as 50 mol % or more, such as 55 mol % or more, such as 60 mol % or more, such as 65 mol % or more, such as 70 mol % or more, such as 75 mol % or more, such as 80 mol % or more, such as 85 mol % or more, such as 90 mol % or more, such as 95 mol % or more based on the weight of the alkylphenol composition. The one or more alkylphenol monomers may be provided in an amount of 95 mol % or less, such as 90 mol % or less, such as 85 mol % or less, such as 80 mol % or less, such as 75 mol % or less, such as 70 mol % or less, such as 65 mol % or less, such as 60 mol % or less, such as 55 mol % or less, such as 50 mol % or less, such as 45 mol % or less, such as 40 mol % or less, such as 35 mol % or less, such as 30 mol % or less, such as 25 mol % or less, such as 20 mol % or less, such as 15 mol % or less based on the weight of the alkylphenol composition.

As indicated above, in addition to the one or more alkylphenol monomers, the alkylphenol composition also comprises one more phenolic monomers. The one or more phenolic monomers may have structural formula (IV) as provided below:

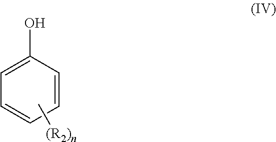

wherein
   R₂ is a C₁₋₄ alkyl; and
   n is 0, 1, or 2.

As indicated above, R₂ is a C₁₋₄ alkyl. In this regard, R₂ may be methyl in one embodiment. When R₂ is methyl, the phenolic monomer may be referred to as a cresol. In this regard, depending on the location of the substitution, the cresol may be o-cresol, m-cresol, p-cresol, or a mixture thereof. In one particular embodiment, the phenolic monomer may include p-cresol.

In another embodiment, R₂ may be propyl, such as n-propyl or isopropyl. In a further embodiment, R₂ may be butyl, such as n-butyl, or sec-butyl.

As indicated above, n is 0, 1, or 2. In one embodiment, n is 0. In such embodiment, the phenolic monomer may be phenol. In another embodiment, n may be 1. In such embodiment, the substitution may be at the para position in one embodiment. In another embodiment, the substitution may be at the ortho position. In a further embodiment, n may be 2. In such embodiment, the substitutions may be at the ortho position and the para position.

Examples of the phenolic monomers may include, but are not limited to, phenol, cresol, propylphenol, and/or butylphenol. In general, certain phenolic monomers as disclosed herein may not be considered a substance of very high concern (SVHC) under certain regulatory schemes, the exposure of which at high levels, as suggested by those schemes, may result in negative effects on human health and the environment. Therefore, even with the use of such phenolic monomers, the process and the resulting novolac resin may be substantially SVHC free.

In one embodiment, the one or more phenolic monomers comprises phenol. In a further embodiment, the one or more phenolic monomers comprises propylphenol (e.g., p-isopropylphenol). In one embodiment, the one or more phenolic monomers comprises a butylphenol (e.g., p-n-butylphenol, p-sec-butylphenol). In another embodiment, the one or more phenolic monomers comprises cresol. The cresol may be o-cresol, m-cresol, p-cresol, or a mixture thereof. In one embodiment, the cresol comprises p-cresol. In a further embodiment, the one or more phenolic monomers comprises phenol and cresol, in particular phenol and p-cresol.

In general, the one or more phenolic monomers may include a mixture. For instance, it may include a mixture of phenolic monomers that fall within the definition of structural formula (IV). In this regard, the one or more phenolic monomers may include any combination of at least a first phenolic monomer, a second phenolic monomer, and/or a third phenolic monomer.

In one embodiment, the one or more phenolic monomers may be provided in an amount of 5 mol % or more, such as 10 mol % or more, such as 15 mol % or more, such as 20 mol % or more, such as 25 mol % or more, such as 30 mol % or more, such as 35 mol % or more, such as 40 mol % or more, such as 45 mol % or more, such as 50 mol % or more, such as 55 mol % or more, such as 60 mol % or more, such as 65 mol % or more, such as 70 mol % or more, such as 75 mol % or more, such as 80 mol % or more, such as 85 mol % or more, such as 90 mol % or more, such as 95 mol % or more based on the weight of the alkylphenol composition. The one or more phenolic monomers may be provided in an amount of 95 mol % or less, such as 90 mol % or less, such as 85 mol % or less, such as 80 mol % or less, such as 75 mol % or less, such as 70 mol % or less, such as 65 mol % or less, such as 60 mol % or less, such as 55 mol % or less, such as 50 mol % or less, such as 45 mol % or less, such as 40 mol % or less, such as 35 mol % or less, such as 30 mol % or less, such as 25 mol % or less, such as 20 mol % or less, such as 15 mol % or less based on the weight of the alkylphenol composition.

In certain embodiments, the one or more alkylphenol monomers and the one or more phenolic monomers may be provided in a certain amount relative to each other. For instance, in one embodiment, the one or more phenolic monomers may be provided in a molar excess than the one or more alkylphenol monomers. In this regard, the molar ratio of the one or more phenolic monomers to the one or more alkylphenol monomers may be greater than 1, such as 2 or more, such as 3 or more, such as 4 or more, such as 5 or more, such as 6 or more, such as 7 or more, such as 8 or more, such as 9 or more, such as 10 or more. The molar ratio may be 20 or less, such as 18 or less, such as 16 or less, such as 14 or less, such as 12 or less, such as 10 or less, such as 9 or less, such as 8 or less, such as 7 or less, such as 6 or less, such as 5 or less. In certain embodiments, the molar ratio may be from 4 to 10, such as from 5 to 10, such as from 6 to 10, such as from 7 to 10, such as from 7 to 9. In some embodiments, the molar ratio may be from 4 to 5.

Further, the one or more phenolic monomers and/or the alkylphenol composition may be substantially free of para-tert-butylphenol (PTBP), para-tert-octylphenol (PTOP), para-nonylphenol (PNP) (branched and linear), para-dodecylphenol (PDDP), 4-heptylphenol (branched and linear), p-hexadecylphenol, or a mixture thereof, particularly para-tert-butylphenol (PTBP), para-tert-octylphenol (PTOP), para-nonylphenol (PNP) (branched and linear), or a mixture thereof. In this regard, such one or more of the aforementioned components may be present in an amount of 1 wt. % or less, such as 0.8 wt. % or less, such as 0.6 wt. % or less, such as 0.4 wt. % or less, such as 0.3 wt. % or less, such as 0.2 wt. % or less, such as 0.1 wt. % or less, such as 0.05 wt. % or less, such as 0.01 wt. % or less, such as 0.005 wt. % or less, such as 0.001 wt. % or less, such as about 0 wt. %. The about 0 wt. % may be a non-detectable amount by GC, LC, or other commonly known measurement method. The aforementioned weight percentages may apply to any individual component in one embodiment or collectively all of the components in another embodiment. In addition, in one embodiment, the aforementioned weight percentages may be based on the weight of the one or more phenolic monomers. In a further embodiment, the aforementioned weight percentages may be based on the weight of the one or more alkylphenol monomers. In another embodiment, the aforementioned weight percentages may be based on the weight of the alkylphenol composition.

In addition, in one embodiment, the alkylphenol composition may be substantially free of resorcinol. In this regard, resorcinol may be present in an amount of 1 wt. % or less, such as 0.8 wt. % or less, such as 0.6 wt. % or less, such as 0.4 wt. % or less, such as 0.3 wt. % or less, such as 0.2 wt. % or less, such as 0.1 wt. % or less, such as 0.05 wt. % or less, such as 0.01 wt. % or less, such as 0.005 wt. % or less, such as 0.001 wt. % or less, such as about 0 wt. %. The about 0 wt. % may be a non-detectable amount by GC, LC, or other commonly known measurement method. In one embodiment, the aforementioned weight percentages may be based on the weight of the one or more phenolic monomer. In another embodiment, the aforementioned weight percentages may be based on the weight of the alkylphenol composition.

The aforementioned one or more alkylphenol monomers and/or one or more phenolic monomers may be obtained from commercial sources in one embodiment. In some embodiments, some or all of the components of the alkylphenol monomers may be formed by alkylation of a phenolic monomer, such as phenol, as disclosed herein using a corresponding olefin (or one or more olefins) in the presence of an alkylation catalyst. For instance, in one embodiment, the phenolic monomer may be a phenol that is alkylated utilizing one or more olefins.

As used herein, the term “olefin” may also be referred to as an “alkylene” or “alkene” and means an unsaturated, linear or branched monovalent hydrocarbon with one or more olefinically unsaturated groups (i.e., carbon-carbon double bonds), such as a vinyl group. In one embodiment, the olefin may be linear. The term “corresponding olefin” refers to an olefin that would result in an alkyl group on the one or more alkylphenol monomers as defined herein. For instance, the olefin would result in an alkyl by alkylation of phenol (e.g., a corresponding olefin for a C₂₄-C₂₈ alkylphenol monomer means a C₂₄-C₂₈ olefin).

In certain embodiments, at least some, such as all, of the one or more alkylphenol monomers may be prepared by alkylation of phenol with one or more corresponding olefins. Suitable alkylation catalysts include acid catalysts, ion exchange resins (e.g., acidic ion exchange resins), acid-activated clays, etc. that are known to one skilled in the art to be useful as an alkylation catalyst.

The molar ratio of phenol to the olefin (or one or more olefins) may be 1 or more. For instance, the molar ratio may be about 1.1 or more, such as about 1.2 or more, such as about 1.3 or more, such as about 1.4 or more, such as about 1.5 2 or more, such as about 3 or more, such as about 4 or more, such as about 5 or more, such as about 6 or more, such as about 7 or more, such as about 8 or more, such as about 9 or more. The molar ratio may be 10 or less, such as 9 or less, such as 8 or less, such as 7 or less, such as 6 or less. The molar ratio may range from about 1.1 to about 10, such as from about 1.2 to about 10, such as from about 1.2 to about 9, such as from about 7 to about 10, such as from about 7 to about 9.

When all of the one or more alkylphenol monomers are prepared by an alkylation reaction, the resulting alkylphenol monomers may be purified (e.g., to remove substantially the excess phenol) before the condensation reaction with the aldehyde and/or the ketone. Alternatively, the resulting product, including the one or more alkylphenol monomers and any unreacted reactants such as excess phenol, may be used directly, without purification (e.g., to remove the excess phenol), for the condensation reaction with the aldehyde and/or the ketone.

### Aldehyde

As indicated above, the alkylphenol composition may be reacted with an aldehyde and/or a ketone as generally known in the art. Any aldehyde and/or ketone known in the art suitable for forming a novolac resin and participating in a condensation reaction with an alkylphenol composition as disclosed herein may be utilized. In one embodiment, the alkylphenol composition may be reacted with an aldehyde. In another embodiment, the alkylphenol composition may be reacted with a ketone.

In general, the aldehyde may include, but is not limited to, formaldehyde, paraformaldehyde, trioxane, acetaldehyde, propionaldehyde, butyraldehyde, trimethylacetaldehyde, acrolein, crotonaldehyde, valeraldehyde, caproaldehyde, heptaldehyde, cyclohexanecarbaldehyde, furfural (e.g., furfural or hydroxymethylfurfural), hexamethylenetriamine, aldol, β hydroxybutyraldehyde, an acetal, furylacrolein, benzaldehyde, terephthalaldehyde, phenylacetaldehyde, α-phenylpropylaldehyde, β-phenylpropylaldehyde, o-hydroxybenzaldehyde, m-hydroxybenzaldehyde, p-hydroxybenzaldehyde, o-methylbenzaldehyde, m-methylbenzaldehyde, p-methylbenzaldehyde, o-chlorobenzaldehyde, m-chlorobenzaldehyde, p-chlorobenzaldehyde, cinnamaldehyde, or a mixture thereof. The aldehydes may be used alone or in combination. In one embodiment, the aldehyde may be formaldehyde. In particular, the formaldehyde may be provided as an aqueous formulation. The formaldehyde may be a 37% aqueous formaldehyde solution in one embodiment. In a further embodiment, the formaldehyde may be a 50% aqueous formaldehyde solution. In another embodiment, the formaldehyde may be provided in an alcohol, such as methanol (also referred to as methylformcel) and/or butanol (also referred to as butylformcel).

The ketone may include, but is not limited to, acetone, methylethylketone, diethylketone, diphenylketone, or a mixture thereof. The ketones may be used alone or in combination.

The aldehyde and/or the ketone, in particular the aldehyde, may be provided for the synthesis in a particular amount. For instance, the molar ratio of the aldehyde and/or the ketone, in particular the aldehyde, to the alkylphenol composition (i.e., the moles of the one or more alkylphenol monomers and the moles of the one or more phenolic monomers) may be about 0.1 or more, such as about 0.2 or more, such as about 0.3 or more, such as about 0.4 or more, such as about 0.5 or more, such as about 0.6 or more, such as about 0.65 or more, such as about 0.7 or more, such as about 0.75 or more, such as about 0.78 or more, such as about 0.8 or more, such as about 0.82 or more, such as about 0.85 or more, such as about 0.9 or more, such as about 0.95 or more, such as about 1 or more, such as about 1.1 or more. The molar ratio may be about 5 or less, such as about 4 or less, such as about 3 or less, such as about 2 or less, such as about 1.8 or less, such as about 1.6 or less, such as about 1.5 or less, such as about 1.4 or less, such as about 1.3 or less, such as about 1.2 or less, such as about 1.1 or less, such as about 1.05 or less, such as about 1 or less, such as about 0.98 or less, such as about 0.95 or less, such as about 0.93 or less, such as about 0.9 or less, such as about 0.88 or less, such as about 0.84 or less. In one embodiment, the aforementioned molar ratio may be with respect to the aldehyde. In one embodiment, the aforementioned molar ratio may be with respect to the one or more alkylphenol monomers. In one embodiment, the aforementioned molar ratio may be with respect to the one or more phenolic monomers.

For instance, the molar ratio may be from about 0.5 to about 3, such as from about 0.5 to about 2, such as from about 0.5 to about 1.5, such as from about 0.6 to about 1.4, such as from about 0.7 to about 1.3, such as from about 0.7 to about 1.2, such as from about 0.7 to about 1.1, such as from about 0.7 to about 1, such as from about 0.7 to about 0.9, such as from about 0.8 to about 1.3, such as from about 0.9 to about 1.3, such as from about 0.9 to about 1.2, such as from about 1 to about 1.2, such as from about 1.1 to about 1.2. In other embodiments, the molar ratio may be from about 0.70 to about 1.5, such as from about 0.70 to about 1.1, such as from about 0.70 to about 0.90, such as from about 0.75 to about 0.90, such as from about 0.80 to about 0.90, such as from about 0.78 to about 0.88, such as from about 0.82 to about 0.88, or such as from about 0.78 to about 0.84

The weight ratio of the aldehyde and/or the ketone, in particular the aldehyde, to the alkylphenol composition (i.e., the weight of the one or more alkylphenol monomers and the weight of the one or more phenolic monomers) may be about 0.001 or more, such as about 0.005 or more, such as about 0.01 or more, such as about 0.02 or more, such as about 0.03 or more, such as about 0.05 or more, such as about 0.08 or more, such as about 0.1 or more, such as about 0.12 or more, such as about 0.15 or more, such as about 0.2 or more, such as about 0.3 or more, such as about 0.4 or more, such as about 0.5 or more, such as about 0.7 or more, such as about 0.8 or more, such as about 0.9 or more, such as about 1 or more. The weight ratio may be about 3 or less, such as about 2 or less, such as about 1.5 or less, such as about 1 or less, such as about 0.9 or less, such as about 0.8 or less, such as about 0.6 or less, such as about 0.4 or less, such as about 0.3 or less, such as about 0.2 or less, such as about 0.15 or less. In one embodiment, the aforementioned weight ratio may be with respect to the aldehyde. In one embodiment, the aforementioned weight ratio may be with respect to the one or more alkylphenol monomers. In one embodiment, the aforementioned weight ratio may be with respect to the one or more phenolic monomers.

### Reaction and Conditions

In general, the general reaction of an alkylphenol composition, including the one or more alkylphenol monomers and the one or more phenolic monomers, with an aldehyde and/or a ketone to prepare a novolac resin is well known in the art. The highly exothermic condensation reaction, so called “novolac condensation,” is carried out by a method including reacting a phenolic compound (e.g., alkylphenol monomer, phenolic monomer as defined herein) with an alkylphenol with an aldehyde, such as formaldehyde, and/or a ketone in the presence of a catalyst.

The method below provides general conditions for preparing the novolac resin. However, in general, the method may include steps and conditions sufficient to form the novolac resin having the concentration of substance of very high concern as disclosed herein, in particular at relatively low concentrations and in some embodiments, at about 0 wt. % based on the weight of the novolac resin.

The method may be carried out in any appropriate reaction vessel. The alkylphenol composition and/or the one or more alkylphenol monomers may be brought to a desired reaction temperature and the aldehyde and/or the ketone may be provided over a period of time. It is also possible to initially introduce only a part of the alkylphenol composition and/or the one or more alkylphenol monomers and to add the rest along with the aldehyde and/or the ketone at a later time. After condensation is complete, the reaction may be neutralized by a base and the water may be removed, such as by distillation. Distillation may also be utilized to further purify the novolac resin to remove other relatively low molecular weight components (e.g., low boilers, para-tert-butylphenol, para-tert-octylphenol, etc.).

In one embodiment, the respective components may be provided together. In another embodiment, the alkylphenol composition may first be provided and thereafter the aldehyde and/or ketone may be provided. When the alkylphenol composition includes more than one component, each component may be provided together. In another embodiment, a first component may be provided first followed by a second component. Upon reacting the components, the resulting mixture may include a novolac resin along with any unreacted components, such as any unreacted components of the alkylphenol composition and/or the aldehyde and/or the ketone.

Further, in one embodiment, the condensation reaction between the alkylphenol composition and the aldehyde and/or the ketone may be carried out in one step, wherein the one or more alkylphenol monomers and the one or more phenolic monomers are reacted with the aldehyde and/or the ketone in a one step reaction. Alternatively, the condensation reaction between the alkylphenol composition and the aldehyde and/or the ketone may be carried out in two steps, wherein the one or more alkylphenol monomers and at least part of the one or more phenolic monomers are reacted with the aldehyde and/or the ketone in two steps.

In some embodiments, the reacting step comprises a first step of reacting the alkylphenol composition comprising the one or more alkylphenol monomers with a first aldehyde and/or ketone to form a first resin; and a second step of reacting the first resin with at least part of the one or more phenolic monomers and a second aldehyde and/or ketone to form a second resin. The first aldehyde and the second aldehyde may be the same or different. In the first step, if the one or more alkylphenol monomers are prepared by alkylation of phenol, and the resulting alkylphenol monomer is used directly, without purification (e.g., to remove the excess phenol), for the condensation reaction, then the alkylphenol composition in the first step would contain the one or more alkylphenol monomers as well as excess phenol (i.e., phenolic monomer), which will react with the aldehyde and/or the ketone. In the second step, an additional amount of the one or more phenolic monomers and a second aldehyde and/or ketone are added to the reaction system to continue the condensation reaction. Regardless of the method utilized, the amount (e.g., weight percentages, molar percentages, and/or molar ratio) of components (e.g., one or more alkylphenol monomers, one or more phenolic monomers) may be within the amounts mentioned herein with respect to each step.

In addition, during the condensation reaction, a small amount of non-reactive organic solvent may be added to the reaction system, to keep the viscosity of the reaction mixture relatively low and to keep the reaction product at a lower temperature until neutralization can be conducted. Suitable solvents include, but are not limited to, a non-reactive, aliphatic (including cycloaliphatic) or aromatic solvent that has a relatively low-viscosity, such as xylene, toluene, benzene, naphthalene, nonane, octane, petroleum fractions, and the like.

The reaction (e.g., condensation reaction) may be conducted at a temperature of 50° C. or more, such as about 60° C. or more, such as about 70° C. or more, such as about 75° C. or more, such as about 80° C. or more, such as about 90° C. or more, such as about 100° C. or more, such as about 105° C. or more, such as about 110° C. or more, such as about 115° C. or more, such as about 130° C. or more, such as about 150° C. or more, such as about 170° C. or more, such as about 190° C. or more. The reaction may be conducted at a temperature of 300° C. or less, such as about 270° C. or less, such as about 240° C. or less, such as about 220° C. or less, such as about 210° C. or less, such as about 200° C. or less, such as about 190° C. or less, such as about 180° C. or less, such as about 170° C. or less, such as about 160° C. or less, such as about 150° C. or less, such as about 140° C. or less, such as about 130° C. or less, such as about 125° C. or less, such as about 120° C. or less, such as about 115° C. or less, such as about 110° C. or less, such as about 100° C. or less, such as about 99° C. or less.

The catalyst is not necessarily limited by the present disclosure. In this regard, the catalyst may be a Friedel Crafts catalyst and/or an acid catalyst. In one particular embodiment, the catalyst may be an acid catalyst. The acid catalyst may be a mineral acid catalyst, an organic acid catalyst, or a mixture thereof. For instance, the acid catalyst may include a mineral acid such as hydrochloric, sulfuric, phosphoric, or phosphorous. The acid catalyst may include an organic acid catalyst, such as formic acid, oxalic acid, a sulfonic acid, or a mixture thereof. The acid catalyst may include a sulfonic acid, such as an alkyl sulfonic acid and/or an arylsulfonic acid. These may include, but are not limited to, methanesulfonic acid, ethanesulfonic acid, benzenesulfonic acid, benzenedisulfonic acid, chlorobenzenesulfonic acid, 3,4-dichlorobenzene sulfonic acid, cresolsulfonic acid, phenol sulfonic acid, toluenesulfonic acid, xylenesulfonic acid, octylphenolsulfonic acid, naphthalenesulfonic acid, 1-naphthol-4-sulfonic acid, dodecylsulfonic acid, dodecylbenzensulfonic acid, etc. as well as mixtures thereof. One preferred catalyst may include an arylsulfonic acid catalyst. For instance, the acid catalyst may include toluenesulfonic acid, xylenesulfonic acid, or dodecylbenzene sulfonic acid. In one particular embodiment, the catalyst may include an acid catalyst which may include dodecylbenzene sulfonic acid.

The catalyst may be provided in an amount necessary for the reaction. In this regard, the catalyst may be present in an amount of about 0.01 wt. % or more, such as about 0.02 wt. % or more, such as about 0.05 wt. % or more, such as about 0.1 wt. % or more, such as about 0.15 wt. % or more, such as about 0.2 wt. % or more, such as about 0.3 wt. % or more, such as about 0.5 wt. % or more, such as about 0.7 wt. % or more, such as about 1 wt. % or more, such as about 1.2 wt. % or more, such as about 1.5 wt. % or more based on the weight of the alkylphenol composition. The catalyst may be present in an amount of about 10 wt. % or less, such as about 8 wt. % or less, such as about 6 wt. % or less, such as about 4 wt. % or less, such as about 3 wt. % or less, such as about 2 wt. % or less, such as about 1.8 wt. % or less, such as about 1.6 wt. % or less, such as about 1.4 wt. % or less, such as about 1.2 wt. % or less, such as about 1.0 wt. % or less, such as about 0.9 wt. % or less, such as about 0.8 wt. % or less, such as about 0.7 wt. % or less, such as about 0.6 wt. % or less, such as about 0.5 wt. % or less, such as about 0.4 wt. % or less, such as about 0.3 wt. % or less based on the weight of the alkylphenol composition.

The molar ratio of the catalyst to the alkylphenol composition (i.e., moles of the one or more alkylphenol monomers and moles of the one or more phenolic monomers) may be 0.0001 or more, such as about 0.0005 or more, such as about 0.001 or more, such as about 0.0015 or more, such as about 0.002 or more, such as about 0.003 or more, such as about 0.005 or more. The molar ratio may be 0.1 or less, such as about 0.05 or less, such as about 0.03 or less, such as about 0.01 or less, such as about 0.008 or less, such as about 0.006 or less, such as about 0.004 or less, such as about 0.003 or less, such as about 0.002 or less.

In one embodiment, the method may further comprise a step of neutralizing the catalyst. In this regard, the method may include a step of providing a base, such as upon completion of the synthesis of the novolac resin. For instance, it may be provided after the condensation reaction. In one embodiment, the neutralization may be conducted before any water removal, such as via distillation. In another embodiment, the neutralization may be conducted after any water removal, such as via distillation.

The base is not necessarily limited by the present disclosure and any base that may neutralize the catalyst, in particular an acid catalyst, may be utilized. The base may include a hydroxide, an amine, ammonia, or a mixture thereof. In one embodiment, the base may include a hydroxide, such as a metal hydroxide. The metal hydroxide may include sodium hydroxide, potassium hydroxide, or a mixture thereof. The hydroxide may also include an ammonium hydroxide, such as a tetrabutylammonium hydroxide. In one embodiment, the base may include an amine. For instance, the amine may include TEA (triethylamine), TEAOH (triethanolamine), diethanolamine, 1,8-diazabicyclo[5.4.0]undec-7-ene (DBU), or a mixture thereof. In one particular embodiment, the base may include triethylamine. In another embodiment, the base may include triethanolamine. In a further embodiment, the base may include ammonia.

The base may be provided in an amount necessary for the neutralization. In this regard, the base may be provided in an amount of about 0.01 wt. % or more, such as about 0.02 wt. % or more, such as about 0.05 wt. % or more, such as about 0.08 wt. % or more, such as about 0.1 wt. % or more, such as about 0.12 wt. % or more, such as about 0.14 wt. % or more, such as about 0.16 wt. % or more, such as about 0.2 wt. % or more, such as about 0.3 wt. % or more, such as about 0.5 wt. % or more, such as about 0.7 wt. % or more, such as about 1 wt. % or more, such as about 1.2 wt. % or more, such as about 1.5 wt. % or more based on the weight of the alkylphenol composition. The base may be present in an amount of about 5 wt. % or less, such as about 4 wt. % or less, such as about 3 wt. % or less, such as about 2 wt. % or less, such as about 1.8 wt. % or less, such as about 1.6 wt. % or less, such as about 1.4 wt. % or less, such as about 1.2 wt. % or less, such as about 1.0 wt. % or less, such as about 0.9 wt. % or less, such as about 0.8 wt. % or less, such as about 0.7 wt. % or less, such as about 0.6 wt. % or less, such as about 0.5 wt. % or less, such as about 0.4 wt. % or less, such as about 0.3 wt. % or less, such as about 0.2 wt. % or less based on the weight of the alkylphenol composition.

The molar ratio of the base to the catalyst may be 0.1 or more, such as about 0.2 or more, such as about 0.3 or more, such as about 0.4 or more, such as about 0.5 or more, such as about 0.6 or more, such as about 0.7 or more, such as about 0.8 or more, such as about 0.9 or more, such as about 1 or more, such as about 1.2 or more, such as about 1.4 or more, such as about 1.6 or more, such as about 1.8 or more, such as about 2 or more. The molar ratio may be 10 or less, such as about 8 or less, such as about 6 or less, such as about 4 or less, such as about 3 or less, such as about 2.8 or less, such as about 2.6 or less, such as about 2.4 or less, such as about 2.2 or less, such as about 2.1 or less, such as about 2 or less, such as about 1.9 or less, such as about 1.8 or less, such as about 1.7 or less, such as about 1.6 or less, such as about 1.5 or less, such as about 1.4 or less, such as about 1.3 or less, such as about 1.2 or less, such as about 1.1 or less, such as about 1 or less.

The molar ratio of the base to the alkylphenol composition (i.e., moles of the one or more alkylphenol monomers and moles of the one or more phenolic monomers) may be 0.0001 or more, such as about 0.0005 or more, such as about 0.001 or more, such as about 0.0015 or more, such as about 0.002 or more, such as about 0.0025 or more, such as about 0.003 or more, such as about 0.005 or more. The molar ratio may be 0.1 or less, such as about 0.05 or less, such as about 0.03 or less, such as about 0.01 or less, such as about 0.008 or less, such as about 0.006 or less, such as about 0.004 or less, such as about 0.003 or less, such as about 0.002 or less.

The method may also include a step of removing any water. For instance, the water may have been generated during the reaction and/or introduced during the reaction. As an example, water may be present within the aqueous formaldehyde utilized in reacting with the alkylphenol. Regardless, such removal step may be conducted after the condensation reaction and prior to the neutralization reaction in one embodiment. In another embodiment, the removal step may be conducted after the neutralization reaction.

The removal of water may be conducted using any technique generally known in the art. For instance, the water may be removed via distillation. As indicated above, distillation may also be utilized to further purify the novolac resin to remove other relatively low molecular weight/volatile components (e.g., low boilers, para-tert-butylphenol, para-tert-octylphenol, etc.).

The distillation may be conducted at atmospheric pressure in one embodiment. The temperature may range from about 120° C. to 150° C., such as from about 125° C. to about 145° C., such as from about 130° C. to about 145° C., such as from about 135° C. to about 145° C.

In another embodiment, the distillation may be conducted under a reduced pressure. For instance, the reduced pressure may be about 150 mbar or less, such as about 100 mbar or less, such as about 50 mbar or less, such as about 30 mbar or less, such as about 20 mbar or less, such as about 15 mbar or less, such as about 10 mbar or less, such as about 5 mbar or less. The distillation may be conducted at a temperature ranging from about 150° C. to about 180° C., such as from about 160° C. to about 180° C., such as from about 165° C. to about 175° C.).

In a further embodiment, atmospheric distillation may be conducted first. Thereafter, distillation under a reduced pressure (i.e., vacuum) may be conducted following the atmospheric distillation.

### Novolac Resin

As indicated above, the method as disclosed herein results in a novolac resin. The novolac resin may have a general structural formula as known in the art. For instance, the formula may include repeating units of the alkylphenol monomer and/or the phenolic monomer. Further, such repeating units may also include a unit formed from the aldehyde and/or the ketone, such as the formaldehyde. Such aldehyde and/or ketone may be utilized to bond adjacent alkylphenol monomers and/or phenolic monomers.

The novolac resin may be linear (e.g., only ortho-ortho reactions), non-linear (e.g., including at least one ortho-para reaction), or a mixture thereof. For instance, in one embodiment, the novolac resin may be a linear resin. In another embodiment, the novolac resin may be a non-linear resin. In a further embodiment, the novolac resin may include a mixture of a linear resin and a non-linear resin.

The novolac resin may have a particular purity such that it includes other components in a relatively low amount. In this regard, other components (e.g., unreacted components, reagents) may be provided in an amount of 5 wt. % or less, such as 4 wt. % or less, such as 3 wt. % or less, such as 2 wt. % or less, such as 1.5 wt. % or less, such as 1 wt. % or less, such as 0.8 wt. % or less, such as 0.6 wt. % or less, such as 0.5 wt. % or less, such as 0.4 wt. % or less, such as 0.3 wt. % or less, such as 0.2 wt. % or less, such as 0.1 wt. % or less based on the weight of the novolac resin. Accordingly, the purity of the novolac resin may be 95 wt. % or more, such as 96 wt. % or more, such as 97 wt. % or more, such as 98 wt. % or more, such as 99 wt. % or more, such as 99.5 wt. % or more, such as 99.6 wt. % or more, such as 99.7 wt. % or more, such as 99.8 wt. % or more, such as 99.9 wt. % or more based on the weight of the novolac resin.

As indicated above, the novolac resin may include a low concentration of other components, such as SVHCs and/or remainder alkylphenol monomers and/or remainder phenolic monomers. In this regard, the novolac resin(s) may include 20 wt. % or less, such as 15 wt. % or less, such as 12 wt. % or less, such as 10 wt. % or less, such as 8 wt. % or less, such as 6 wt. % or less, such as 5 wt. % or less, such as 4 wt. % or less, such as 3 wt. % or less, such as 2 wt. % or less, such as 1 wt. % or less, such as 0.5 wt. % or less of such components based on the weight of the novolac resin. In one embodiment, such aforementioned weight percentages may be with respect to any remainder (or unreacted) one or more alkylphenol monomers. In one embodiment, such aforementioned weight percentages may be with respect to any remainder (or unreacted) one or more phenolic monomers.

In one embodiment, the novolac resin may also contain a relatively low concentration of phenol. For instance, phenol may be present in an amount of about 5 wt. % or less, such as about 4 wt. % or less, such as about 3.5 wt. % or less, such as about 3 wt. % or less, such as about 2.5 wt. % or less, such as about 2 wt. % or less, such as about 1.8 wt. % or less, such as about 1.6 wt. % or less, such as about 1.4 wt. % or less, such as about 1.2 wt. % or less, such as about 1 wt. % or less, such as about 0.9 wt. % or less, such as about 0.8 wt. % or less, such as about 0.7 wt. % or less, such as about 0.6 wt. % or less, such as about 0.5 wt. % or less, such as about 0.4 wt. % or less, such as about 0.3 wt. % or less, such as about 0.2 wt. % or less, such as about 0.1 wt. % or less. Phenol may be present in an amount of 0 wt. % or more, such as about 0.001 wt. % or more, such as about 0.005 wt. % or more, such as about 0.01 wt. % or more, such as about 0.03 wt. % or more, such as about 0.05 wt. % or more, such as about 0.08 wt. % or more, such as about 0.1 wt. % or more, such as about 0.2 wt. % or more, such as about 0.3 wt. % or more, such as about 0.4 wt. % or more, such as about 0.5 wt. % or more, such as about 1 wt. % or more. In one embodiment, the aforementioned weight percentages may be based on the weight of the novolac resin. In a further embodiment, the aforementioned weight percentages may be based on the weight of the initial amount of phenol utilized in the process.

The novolac resin may also contain a relatively low concentration of free alkenes (or olefins). For instance, free alkenes may be present in an amount of about 5 wt. % or less, such as about 4 wt. % or less, such as about 3.5 wt. % or less, such as about 3 wt. % or less, such as about 2.5 wt. % or less, such as about 2 wt. % or less, such as about 1.8 wt. % or less, such as about 1.6 wt. % or less, such as about 1.4 wt. % or less, such as about 1.2 wt. % or less, such as about 1 wt. % or less, such as about 0.9 wt. % or less, such as about 0.8 wt. % or less, such as about 0.7 wt. % or less, such as about 0.6 wt. % or less, such as about 0.5 wt. % or less, such as about 0.4 wt. % or less, such as about 0.3 wt. % or less, such as about 0.2 wt. % or less, such as about 0.1 wt. % or less. Free alkenes may be present in an amount of 0 wt. % or more, such as about 0.001 wt. % or more, such as about 0.005 wt. % or more, such as about 0.01 wt. % or more, such as about 0.03 wt. % or more, such as about 0.05 wt. % or more, such as about 0.08 wt. % or more, such as about 0.1 wt. % or more, such as about 0.2 wt. % or more, such as about 0.3 wt. % or more, such as about 0.4 wt. % or more, such as about 0.5 wt. % or more, such as about 1 wt. % or more. In one embodiment, the aforementioned weight percentages may be based on the weight of the novolac resin.

Further, the novolac resin may be substantially free of resorcinol. In this regard, resorcinol may be present in an amount of 1 wt. % or less, such as 0.8 wt. % or less, such as 0.6 wt. % or less, such as 0.4 wt. % or less, such as 0.3 wt. % or less, such as 0.2 wt. % or less, such as 0.1 wt. % or less, such as 0.05 wt. % or less, such as 0.01 wt. % or less, such as 0.005 wt. % or less, such as 0.001 wt. % or less, such as about 0 wt. % based on the weight of the novolac resin. The about 0 wt. % may be a non-detectable amount by GC, LC, or other commonly known measurement method.

Further, the novolac resin may be substantially free of para-tert-butylphenol (PTBP), para-tert-octylphenol (PTOP), para-nonylphenol (PNP) (branched and linear), para-dodecylphenol (PDDP), 4-heptylphenol (branched and linear), p-hexadecylphenol, or a mixture thereof, particularly para-tert-butylphenol (PTBP), para-tert-octylphenol (PTOP), para-nonylphenol (PNP) (branched and linear), or a mixture thereof. In this regard, such one or more of the aforementioned components may be present in an amount of 1 wt. % or less, such as 0.8 wt. % or less, such as 0.6 wt. % or less, such as 0.4 wt. % or less, such as 0.3 wt. % or less, such as 0.2 wt. % or less, such as 0.1 wt. % or less, such as 0.05 wt. % or less, such as 0.01 wt. % or less, such as 0.005 wt. % or less, such as 0.001 wt. % or less, such as about 0 wt. % based on the weight of the novolac resin. The about 0 wt. % may be a non-detectable amount by GC, LC, or other commonly known measurement method. The aforementioned weight percentages may apply to any individual component in one embodiment or collectively all of the components in another embodiment.

The novolac resin may have a particular softening point of about 50° C. or more, such as about 60° C. or more, such as about 70° C. or more, such as about 75° C. or more, such as about 80° C. or more, such as about 85° C. or more, such as about 90° C. or more, such as about 93° C. or more, such as about 95° C. or more, such as about 98° C. or more, such as about 100° C. or more, such as about 105° C. or more, such as about 110° C. or more, such as about 120° C. or more, such as about 130° C. or more. The novolac resin may have a particular softening point of about 150° C. or less, such as about 140° C. or less, such as about 135° C. or less, such as about 130° C. or less, such as about 125° C. or less, such as about 120° C. or less, such as about 115° C. or less, such as about 110° C. or less, such as about 105° C. or less, such as about 103° C. or less, such as about 101° C. or less, such as about 100° C. or less, such as about 99° C. or less, such as about 98° C. or less, such as about 97° C. or less, such as about 96° C. or less, such as about 95° C. or less. The softening point may be determined using a dropping point test in accordance with ASTM D6090-17.

The novolac resin may have a particular glass transition temperature of about 30° C. or more, such as about 35° C. or more, such as about 40° C. or more, such as about 45° C. or more, such as about 50° C. or more, such as about 55° C. or more, such as about 60° C. or more, such as about 65° C. or more, such as about 70° C. or more, such as about. The novolac resin may have a glass transition temperature of about 150° C. or less, such as about 130° C. or less, such as about 110° C. or less, such as about 100° C. or less, such as about 90° C. or less, such as about 85° C. or less, such as about 80° C. or less, such as about 75° C. or less. The glass transition temperature may be determined according to ASTM E1356-08(2014).

The novolac resin may have a particular number average molecular weight. For instance, the number average molecular weight may be about 500 g/mol or more, such as about 600 g/mol or more, such as about 700 g/mol or more, such as about 800 g/mol or more, such as about 900 g/mol or more, such as about 1000 g/mol or more, such as about 1100 g/mol or more, such as about 1200 g/mol or more, such as about 1300 g/mol or more, such as about 1500 g/mol or more, such as about 1700 g/mol or more, such as about 2000 g/mol or more. The number average molecular weight may be about 5000 g/mol or less, such as about 4500 g/mol or less, such as about 4000 g/mol or less, such as about 3500 g/mol or less, such as about 3000 g/mol or less, such as about 2800 g/mol or less, such as about 2500 g/mol or less, such as about 2300 g/mol or less, such as about 2100 g/mol or less, such as about 2000 g/mol or less, such as about 1900 g/mol or less, such as about 1800 g/mol or less, such as about 1600 g/mol or less, such as about 1400 g/mol or less, such as about 1200 g/mol or less, such as about 1000 g/mol or less, such as about 800 g/mol or less. The molecular weight may be determined using means generally known in the art, such as gel permeation chromatography.

### Applications

The novolac resin as defined herein may be utilized in a wide variety of applications. These may include, but are not limited to, rubbers, adhesives, dispersants, surfactants, emulsifiers, elastomers, coating, painting, thermoplastic elastomers, engineering resins, ink components, lubricants, polymer blend components, paper additives, biomaterials, water treatment additives, cosmetics components, antistatic agents, food and beverage packaging materials, release compounding agents in pharmaceuticals applications, etc.

Particularly, the novolac resin may be utilized as tackifiers. In this regard, the novolac resin may be utilized in a tackifier composition. In particular, they may be utilized as tackifiers for rubber compositions and ultimately rubber products. In general and without intending to be limited by theory, the novolac resin described herein may impart a tack to the rubber composition that is comparable to, or better than, the tack imparted by a tackifier comprising a novolac resin prepared from a C₃-C₁₆ alkylphenol monomer (e.g., a para-substituted C₃-C₁₂ alkylphenol monomer, a para-substituted C₄-C₉ alkylphenol monomer such as para-tert-octylphenol and/or para-tert-butylphenol), in particular one utilizing a C₃-C₁₆ alkylphenol monomer that may be considered an SVHC phenolic compound.

In this regard, a novolac resin as defined herein may be provided to a rubber. In this regard, a rubber composition may include the novolac resin as defined herein and the rubber. The rubber itself may include a single rubber or a mixture of rubbers. Further, a final rubber product made from the rubber composition may also include the novolac resin as defined herein as well as the rubber.

The rubber is not necessarily limited by the present disclosure. For instance, the rubber may be a natural rubber, a synthetic rubber, or a mixture thereof. In one embodiment, the rubber may include a natural rubber. In another embodiment, the rubber may include a synthetic rubber. In a further embodiment, the rubber may include a mixture of a natural rubber and a synthetic rubber.

As indicated, the rubber may include a synthetic rubber. Examples of synthetic rubber include, but are not limited to, diene-based synthetic rubbers, such as homopolymers of conjugated diene monomers, and copolymers and terpolymers of the conjugated diene monomers with monovinyl aromatic monomers and trienes. Exemplary diene-based compounds include, but are not limited to, polyisoprene such as 1,4-cis-polyisoprene and 3,4-polyisoprene; neoprene; polystyrene; polybutadiene; 1,2-vinyl-polybutadiene; butadiene-isoprene copolymer; butadiene-isoprene-styrene terpolymer; isoprene-styrene copolymer; styrene/isoprene/butadiene copolymers; styrene/isoprene copolymers; emulsion styrene-butadiene copolymers; solution styrene/butadiene copolymers; butyl rubber such as isobutylene rubber; ethylene/propylene copolymers such as ethylene propylene diene monomer (EPDM); and blends thereof. A rubber component, having a branched structure formed by use of a polyfunctional modifier such as tin tetrachloride, or a multifunctional monomer such as divinyl benzene, may also be used. Additional suitable rubber compounds include nitrile rubber, acrylonitrile-butadiene rubber (NBR), silicone rubber, fluoroelastomers, ethylene acrylic rubber, ethylene vinyl acetate copolymer (EVA), epichlorohydrin rubbers, chlorinated polyethylene rubbers such as chloroprene rubbers, chlorosulfonated polyethylene rubbers, hydrogenated nitrile rubbers, hydrogenated isoprene-isobutylene rubbers, tetrafluoroethylene-propylene rubbers, and blends thereof.

As indicated above, the rubber may include a mixture of a natural rubber and a synthetic rubber. For instance, the rubber can be a natural rubber/polybutadiene rubber blend, a styrene butadiene rubber-based blend, such as a styrene butadiene rubber/natural rubber blend, or a styrene butadiene rubber/butadiene rubber blend. When using a blend of rubbers, the blend ratio between different natural rubbers or synthetic rubbers can be flexible, depending on the properties desired for the rubber and rubber composition.

The novolac resin may be added to a rubber in an amount of about 0.1 phr or more, such as about 0.2 phr or more, such as about 0.3 phr or more, such as about 0.5 phr or more, such as about 0.7 phr or more, such as about 0.9 phr or more, such as about 1 phr or more, such as about 1.3 phr or more, such as about 1.5 phr or more, such as about 1.8 phr or more, such as about 2 phr or more, such as about 2.3 phr or more, such as about 2.5 phr or more, such as about 2.8 phr or more, such as about 3 phr or more, such as about 3.3 phr or more, such as about 3.5 phr or more, such as about 3.8 phr or more. The novolac resin may be added to a rubber in an amount of about 50 phr or less, such as about 40 phr or less, such as about 30 phr or less, such as about 25 phr or less, such as about 20 phr or less, such as about 15 phr or less, such as about 10 phr or less, such as about 9 phr or less, such as about 8 phr or less, such as about 7 phr or less, such as about 6 phr or less, such as about 5.8 phr or less, such as about 5.5 phr or less, such as about 5.2 phr or less, such as about 5 phr or less, such as about 4.5 phr or less, such as about 4 phr or less, such as about 3.8 phr or less, such as about 3.5 phr or less, such as about 3.2 phr or less, such as about 3 phr or less, such as about 2.8 phr or less, such as about 2.5 phr or less, such as about 2.2 phr or less, such as about 2 phr or less, such as about 1.8 phr or less, such as about 1.6 phr or less, such as about 1.4 phr or less, such as about 1.2 phr or less, such as about 1 phr or less.

Furthermore, it should be understood that more than one novolac resin as defined herein may be provided to the rubber. Accordingly, a single novolac resin as defined herein or a mixture of novolac resins as defined herein may be incorporated with the rubber to provide a rubber composition and resulting rubber product.

The novolac resin may be provided to an unvulcanized rubber either together or separate from crosslinking agents. Furthermore, other conventional additives may also be utilized in the rubber composition. These may include, but are not limited to, rubber additives (e.g., carbon black), reinforcing materials, fillers (e.g., zinc oxide), vulcanizing/curing agents (e.g., sulfur curing agents), methylene donor agents, accelerators (e.g., sulfur curing accelerators), retarders, activators, processing auxiliaries, oils, plasticizers, pigments, fatty acids (e.g., stearates), adhesive promoters, waxes, antioxidants, antiozonants, peptizing agents, etc. and the like. As known to one skilled in the art, these additional materials are selected and commonly used in conventional amounts.

Methylene donor agents in a rubber composition are capable of generating a methylene radical by heating upon cure (vulcanization). Suitable methylene donor agents include, for instance, hexamethylenetetramine (HMTA), di-, tri-, tetra-, penta-, or hexa-N-methylol-melamine or their partially or completely etherified or esterified derivatives, for example hexa(methoxymethyl)melamine (HMMM), oxazolidine or N-methyl-1,3,5-dioxazine, and mixtures thereof. Additional examples for suitable methylene donor agents may be found in U.S. Pat. No. 3,751,331, which is incorporated herein by reference in its entirety. The methylene donor agents can be used in an amount ranging from about 0.1 to about 50 phr (parts per hundred rubber), for instance, from about 0.5 to about 25 phr, such as from about 0.5 to about 10 phr, such as from about 1.5 to about 7.5 phr, such as from about 1.5 to about 5 phr.

Suitable sulfur curing (vulcanizing) agents include, but are not limited to, rubbermakers sulfur; sulfur donating vulcanizing agents, such as an amine disulfide, polymeric polysulfide or sulfur olefin adducts; and insoluble polymeric sulfur. For instance, the sulfur curing agent may be soluble sulfur or a mixture of soluble and insoluble polymeric sulfur. The sulfur curing agents can be used in an amount ranging from about 0.1 to about 15 phr, such as from about 1.0 to about 10 phr, such as from about 1.5 to about 7.5 phr, such as from about 1.5 to about 5 phr. Such agents may be utilized to cure or vulcanize the rubber composition which may further reduce any hysteresis increase.

Suitable sulfur curing (vulcanizing) accelerators include, but are not limited to, a thiazole such as 2-mercaptobenzothiazole (MBT), 2-2′-dithiobis(benzothiazole) (MBTS), zinc-2-mercaptobenzothiazole (ZMBT); a thiophosphate such as zinc-O,O-di-N-phosphorodithioate (ZBDP); a sulfenamide such as N-cyclohexyl-2-benzothiazole sulfenamide (CBS), N-tert-butyl-2-benzothiazole sulfenamide (TBBS), 2-(4-morpholinothio)-benzothiazole (MBS), N,N′-dicyclohexyl-2-benzothiazole sulfenamide (DCBS); a thiourea such as ethylene thiourea (ETU), di-pentamethylene thiourea (DPTU), dibutyl thiourea (DBTU); a thiuram such as tetramethylthiuram monosulfide (TMTM), tetramethylthiuram disulfide (TMTD), dipentamethylenethiuram tetrasulfide (DPTT), tetrabenzylthiuram disulfide (TBzTD); a dithiocarbamate such as zinc dimethyldithiocarbamate (ZDMC), zinc diethyldithiocarbamate (ZDEC), zinc dibutyldithiocarbamate (ZDBC), zinc dibenzyldithiocarbamate (ZBEC); and a xanthate such as zinc-isopropyl (ZIX). Additional examples for suitable sulfur curing accelerators may be found in U.S. Pat. No. 4,861,842, which is incorporated herein by reference in its entirety. The sulfur curing accelerators can be used in an amount ranging from about 0.1 to about 25 phr, such as from about 1.0 to about 10 phr, such as from about 1.5 to about 7.5 phr, such as from about 1.5 to about 5 phr.

Suitable other rubber additives include, for instance, zinc oxide, carbon black, silica, wax, antioxidant, antiozonant, peptizing agent, fatty acid, stearate, curing agent, activator, retarder (e.g., scorch retarder), cobalt source, adhesion promoter, plasticizer, pigment, and mixtures thereof.

Suitable reinforcing materials include, for instance, nylon, rayon, polyester, aramid, glass, steel (brass, zinc or bronze plated), or other organic and inorganic compositions. These reinforcing materials may be in the form of, for instance, filaments, fibers, cords, or fabrics.

Suitable oils include, for instance, mineral oils and naturally derived oils. Examples of naturally derived oils include tall oil, linseed oil, cashew nut shell liquid, soybean oil, and/or twig oil. Other oils may also include, but are not limited to, paraffinic oil, naphthenic oil, etc. as well as mixtures thereof. The oils may be contained in the rubber composition, relative to the total weight of rubber, in amounts less than about 5 wt %, such as less than about 2 wt %, such as less than about 1 wt %, such as less than about 0.6 wt %, such as less than about 0.4 wt %, such as less than about 0.3 wt %, such as less than about 0.2 wt %. The presence of an oil in the rubber composition may aid in providing improved flexibility of the rubber composition after vulcanization.

The rubber composition may be utilized in various applications. For instance, the rubber composition may be utilized to make rubber products via typical molding processes that may also include or utilize general curing processes of the rubber composition in making the rubber product. For instance, regardless of the rubber product and the application, the rubber product can be built, shaped, molded and cured by various methods known to one skilled in the art.

In general, the rubber composition may be utilized to make various rubber products or articles. The rubber product or article may include industrial rubber goods, such as damping elements, rubber sleeves, bellows, conveyor belts, tires or tire components, etc. The novolac resin as defined herein may also be utilized for other applications. For instance, these may include, but are not limited to, hoses, power belts, conveyor belts, printing rolls, friction linings, impregnating agents for organic and/or inorganic fibers, binders for organic and/or inorganic fibers, coatings, finishes and paints and also binders for comminuted, preferably inorganic, materials.

In one embodiment, the rubber product may be a tire or a tire component. These may include, but are not limited to, a sidewall, a shoulder, a tread (or treadstock, subtread), a bead, a ply, a belt, a rim strip, an inner liner, a chafer, a carcass ply, a body ply skim, wire skim coat, a bead filler, an overlay compound for tire, or any tire part that can be made of rubber. A more extensive discussion of various tire parts/components can be found in U.S. Pat. Nos. 3,542,108 and 3,648,748, which are incorporated herein by reference in their entirety.

### EXAMPLES

### Test Methods

Unless expressly mentioned below utilizing a different method, the general method for determining tack performance is as follows. In particular, the novolac resin (at 4 phr or unless stated otherwise) is mixed and milled with a rubber according to standard practices for mixing and milling. Prior to the unaged tack measurement, 330 grams of each sample was milled at a nip of 80 mils opening with the temperature for the rolls set to 46° C. and 21 rpm for the rear roll on the mill. The material is spread evenly across the rollers and milled for 1 minute to homogenize. The rubber is then sheeted out at an approximately 3 mm thickness, and the sheet is laid out flat on a benchtop at room temperature, with the milled side facing up for measurement. A Toyoseiki Tackiness Checker HTC-1 handheld tack tester, placed directly on top of the rubber sheet, is used to measure tack across the sheet, gathering 8 individual measurements for each aging period. The tack tester works by pressing a stainless-steel wheel to the rubber sheet at a force of 12 Newtons for a time of 3 seconds. Afterwards, the test wheel is raised from the rubber sheet and the force required for the stainless-steel wheel to be separated from the rubber sheet specimen is recorded as the pull off force (tack), in Newtons. The average of the 8 measurements taken is then reported and the error is reported as ±1 standard deviation unit away from the mean.

For any aged samples, the rubber sheets are placed in a humidity chamber for aging. Aging of the milled rubber sheets is performed at desired conditions (such as ambient temperature (21±2° C.) and 90% relative humidity (RH)) for a desired period of time (such as 24 or 72 hours). For the aged measurement, the rubber sheet is removed from the humidity chamber and the tack is measured immediately. If further aging is required, the rubber sheet is promptly returned to the humidity chamber after tack measurements are completed.

### Example 1

This example demonstrates the synthesis of a novolac resin utilizing a C₂₄-C₂₈ alkylphenol monomer and para-sec butylphenol. A 500 mL four-neck round-bottom flask, equipped with a nitrogen inlet, was charged with C₂₄-C₂₈ alkylphenol monomer (51.0 g, 0.11 mol), para-sec-butylphenol (94.7 g, 0.63 mol), dodecylbenzene sulfonic acid (DDBSA) (0.4 g, 0.0012 mol), and silicone antifoam (0.15 mL). The mixture was heated to 120° C. Stirring was initiated at 250 rpm using an overhead stirrer equipped with a fixed blade when the mixture was fully melted. Subsequently, a 37% formaldehyde solution (57.4 g) was added dropwise with a rate of 20 mL/h under a nitrogen atmosphere to facilitate active distillation. Upon complete addition of formaldehyde, the reaction mixture was held at 120° C. for 30 minutes. The batch was then neutralized with 1,8-diazabicyclo[5.4.0]undec-7-ene (DBU), and the temperature was increased to 140° C. for atmospheric distillation. Vacuum distillation was initiated gradually, achieving full vacuum at 140° C. The reaction mixture was further heated to 170° C. under full vacuum (30 in. Hg) and held for 30 minutes. Following this, the system was depressurized, and the resin was transferred into a pan and allowed to cool to room temperature. The softening point of the resulting novolac resin is 98° C.

### Example 2

This example demonstrates the tack performance of certain novolac resins in rubber compositions and rubber products.

The tack performance of the rubber samples was measured after mixing and milling of the tackifier with a rubber according to standard practices for mixing and milling. Prior to the unaged tack measurement, 330 grams of each sample of filled elastomer were milled at a nip of 80 mils opening with the temperature for the rolls set to 46° C. and 21 rpm for the rear roll on the mill. The material was spread evenly across the rollers and milled for 1 minute to homogenize. The rubber was then sheeted out at an approximately 3 mm thickness, and the sheet was laid out flat on a benchtop at room temperature, with the milled side facing up for measurement. A Toyoseiki Tackiness Checker HTC-1 handheld tack tester, placed directly on top of the rubber sheet, was used to measure tack across the sheet, gathering 8 individual measurements for each aging period. The tack tester worked by pressing a stainless-steel wheel to the rubber sheet at a force of 12 Newtons for a time of 3 seconds. Afterwards, the test wheel was raised from the rubber sheet at a rate of 2.3 mm/sec and the force required for the stainless-steel wheel to be separated from the rubber sheet specimen was recorded as the pull off force (tack), in Newtons. The average of the 8 measurements taken was then reported and the error was reported as ±1 standard deviation unit away from the mean.

After the unaged tack measurement, the rubber sheets were placed in the humidity chamber for aging. Aging of the milled rubber sheets was performed at ambient temperature (21±2° C.) and 90% relative humidity (RH) for a period of 24 and 72 hours. For the aged measurement, the rubber sheet was removed from the humidity chamber and the tack was measured immediately. If further aging was required, the sheet was promptly returned to the humidity chamber after tack measurements were completed.

In this example, the rubber formulations below were utilized to model different types and parts of a tire. All of the compounding was performed in a Banbury® mixer. The mixing conditions were according to general processes known in the art. All the samples within an experiment were mixed to the same phr loading level for each ingredient, and under the same conditions.

In each formulation below, the column labeled “Tackifier” represents the combination of ingredients within that formulation that contain any type of tackifying resin. For example, for the silica tread formulation given, a filled-elastomer compound was mixed that contained either 4.00 phr of SP-1068 phenolic tackifier (p-tertoctylphenol based resin), 4.00 parts of SVHC-free tackifier (composed of 25 mol % p-cresol, 75 mol % C₂₄₋₂₈ alkylphenol monomer, and formaldehyde—F2P ratio of 0.90), or 4.00 parts of any other tackifier, along with the remainder of the ingredients in the formula. In each experiment, SP-1068 was used as a control resin for comparison of performance. A blank sample was also included in many of the studies wherein the blank sample contained all of the same ingredients at the same loadings as the tackifier resin samples tested, except it contained no tackifier resin. This sample provides a baseline tack for the formulations and was used for comparison purposes.

TABLE 1
Silica tread formulation (in phr)

| | | Blank | Tackifier |
|---|---|---|---|
| NP1 | Styrene-butadiene rubber | 95.48 | 95.48 |
| | Neodymium butadiene rubber | 25.00 | 25.00 |
| | Aromatic oil | 11.53 | 11.53 |
| | Silica | 75.00 | 75.00 |
| | Multifunctional silane coupling agent | 6.00 | 6.00 |
| | NP1 PHR | 213.00 | 213.00 |
| NP2 | NP1 MB | 213.00 | 213.00 |
| | Carbon black | 12.00 | 12.00 |
| | 6PPD | 2.00 | 2.00 |
| | TMQ | 2.00 | 2.00 |
| | Microcrystalline wax | 1.50 | 1.50 |
| | Tackifier resin | — | 4.00 |
| | Zinc oxide | 2.50 | 2.50 |
| | Stearic acid | 1.00 | 1.00 |
| | NP2 PHR | 234.00 | 238.00 |
| Prod | NP2 MB | 234.00 | 238.00 |
| Pass | Sulfur (rubber grade) | 1.40 | 1.40 |
| | Accelerator | 1.70 | 1.70 |
| | Diphenylguanidine | 2.00 | 2.00 |
| | Prod Pass PHR | 239.10 | 243.10 |

TABLE 2
Sidewall formulation (in phr)

| | | Blank | Tackifier |
|---|---|---|---|
| NP1 | Natural rubber | 50.00 | 50.00 |
| | Polybutadiene rubber | 50.00 | 50.00 |
| | Zinc oxide | 3.50 | 3.50 |
| | Aromatic oil | 7.00 | 7.00 |
| | TMQ | 1.00 | 1.00 |
| | Microcrystalline wax | 2.00 | 2.00 |
| | 6PPD | 3.00 | 3.00 |
| | Stearic acid | 2.00 | 2.00 |
| | Carbon black | 50.00 | 50.00 |
| | Tackifier resin | — | 4.00 |
| | NP2 PHR | 57.00 | 61.00 |
| Prod | NP1 MB | 168.50 | 172.50 |
| Pass | Sulfur (rubber grade) | 1.50 | 1.50 |
| | Accelerator | 0.80 | 0.80 |
| | CTP (PVI) | 0.27 | 0.27 |
| | Prod Pass PHR | 171.07 | 175.07 |

TABLE 3
Inner liner formulation (in phr)

| | | Blank | Tackifier |
|---|---|---|---|
| NP1 | Brominated isobutylene-isoprene copolymer | 100.00 | 100.00 |
| | Naphthenic process oil | 8.00 | 8.00 |
| | Tackifying resin | — | 4.00 |
| | Stearic acid | 2.00 | 2.00 |
| | Hydrocarbon resin | 7.00 | 7.00 |
| | Magnesium oxide | 0.15 | 0.15 |
| | Carbon black | 60.00 | 60.00 |
| | NP1 PHR | 177.15 | 181.15 |
| Prod | NP1 MB | 177.15 | 181.15 |
| Pass | Sulfur (rubber grade) | 0.50 | 0.50 |
| | Zinc oxide | 1.00 | 1.00 |
| | MBTS | 1.50 | 1.50 |
| | Prod Pass PHR | 180.15 | 184.15 |

TABLE 4
Chafer strip formulation (in phr)

| | | Blank | Tackifier |
|---|---|---|---|
| NP1 | Neodymium butadiene rubber | 75.00 | 75.00 |
| | Natural rubber | 25.00 | 25.00 |
| | Aromatic oil | 3.00 | 3.00 |
| | Microcrystalline wax | 2.00 | 2.00 |
| | 6PPD | 3.00 | 3.00 |
| | Stearic acid | 2.00 | 2.00 |
| | Tackifier resin | — | 4.00 |
| | Zinc oxide | 4.00 | 4.00 |
| | Carbon black | 80.00 | 80.00 |
| | NP1 PHR | 194.00 | 198.00 |
| Prod | NP1 MB | 194.00 | 198.00 |
| Pass | Sulfur (rubber grade) | 2.50 | 2.50 |
| | Accelerator | 1.20 | 1.20 |
| | Prod Pass PHR | 197.70 | 201.70 |

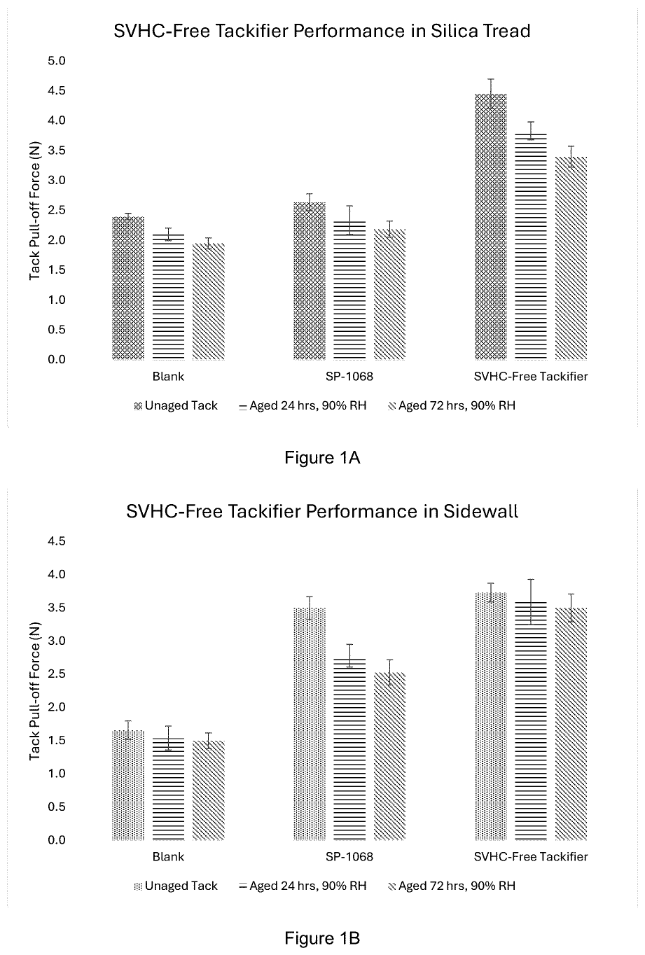

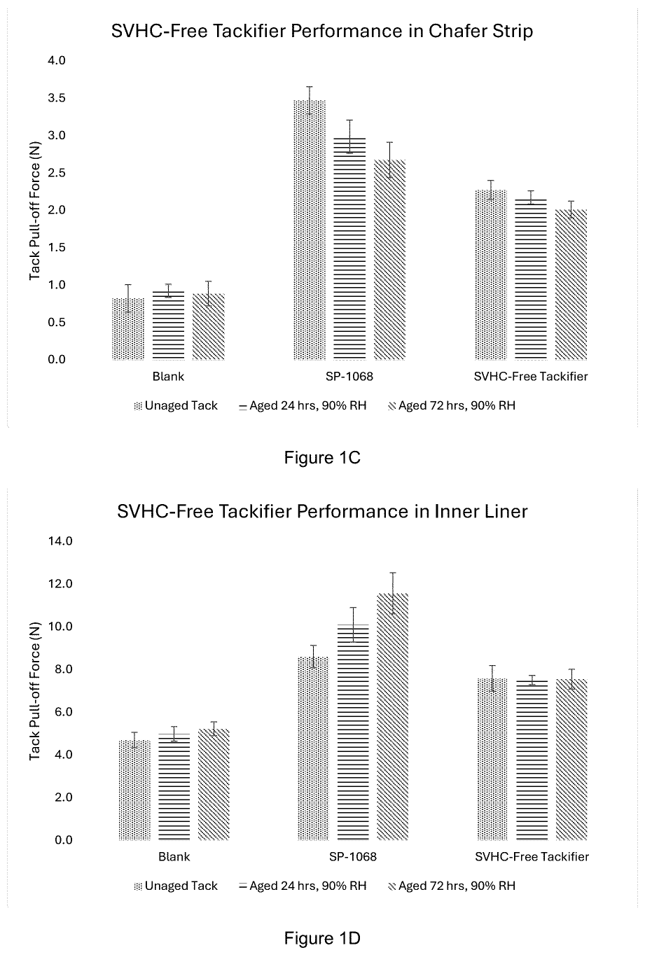

The tackifier performance was analyzed for each of these formulations. FIG. 1A illustrates the tack performance in a silica tread. In general, the SVHC-free tackifier was shown to provide excellent unaged and aged tack performance versus the blank and SP-1068 samples. For instance, the blank provided an unaged tack value of approximately 2.4 N, while the SP-1068 provided only slightly better performance at 2.6 N. In contrast, the SVHC-free tackifier produced a tack response of 4.5 N.

FIG. 1B illustrates the tack performance in a sidewall. For the sidewall formulation, both SP-1068 and the SVHC-free tackifier provided over twice the tack pull-off force values than the blank. Furthermore, the SVHC-free tackifier was shown to have better aged performance, retaining nearly all tackiness of the unaged compound, while SP-1068 tack was shown to decline over the three-day aging period.

FIG. 1C illustrates the tack performance in a chafer strip. The SVHC-free tackifier was shown to provide over twice the tack pull-off force versus the blank compound in the chafer strip. SP-1068, however, was shown to outperform the SVHC-free tackifier, with nearly 1 N force greater tack force, and approximately 3 N greater force when compared with the blank.

FIG. 1D illustrates the tack performance in an inner liner. SP-1068 provided slightly higher tack response than the SVHC-free tackifier, especially after aging. The SVHC-free tackifier, however, was shown to provide an increased tack response of approximately 3 N to the already tacky inner liner compared to the blank compound. Once again, the SVHC-free tackifier showed stable performance between unaged and aged testing.

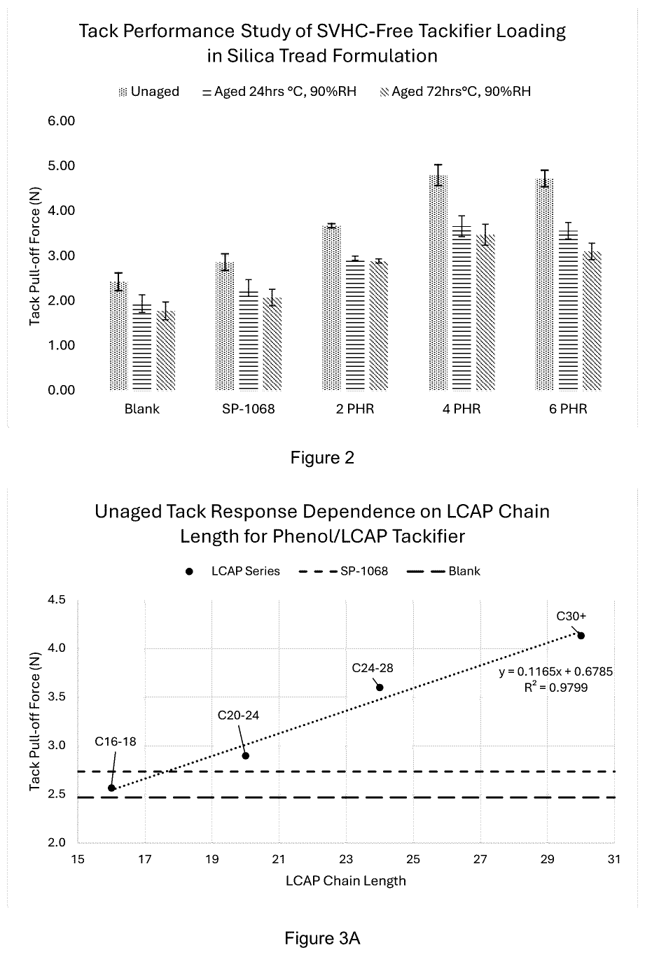

In addition, the loading of the tackifier was modified to determine the effect on tack performance as illustrated in FIG. 2. In particular, the loading of the p-cresol/LCAP2428 novolac resin tackifier in the silica tread formulation. Instead of the usual 4.0 phr loading of tackifier resin in the silica tread formulation (Table 1), loadings of the SVHC-free tackifier were varied from 2.0 to 6.0 phr. In addition, the blank included 0 phr of tackifier resin while SP-1068 was used in the same amount of 4.0 phr. Results of the loading study show an increase in tack for the SVHC-free tackifier at 4.0 phr versus SP-1068 at an equivalent loading. At a loading of 6.0 phr, no improvement in tack performance was observed. Interestingly, a loading of 2.0 phr of the SVHC-free tackifier in the silica tread formulation still showed improved tack performance over the SP-1068 sample, at twice the loading.

### Example 3

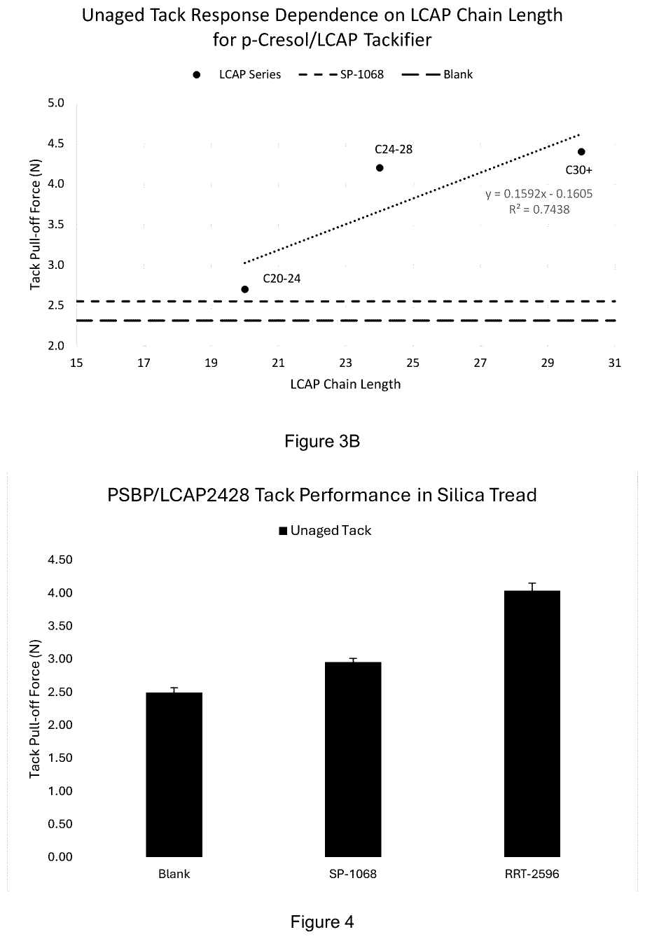

The effect on the alkyl chain length of the alkylphenol monomer in a phenol/alkylphenol novolac resin was determined as illustrated in FIG. 3. In particular, an experiment was conducted to study the effect of changing the chain length of the alkylphenol monomer incorporated into the novolac resin made from phenol, the alkylphenol monomer, and formaldehyde. The alkyl chain lengths ranged from a mixture of C₁₆₋₁₈ to a length of C₃₀₊. The general result showed a correlation between an increase in alkyl chain length with an increase in tack performance. Samples used in the study are shown below, along with the softening point measured for each novolac resin.

TABLE 5
List of samples included in the study of phenol/alkylphenol
monomer tackifier chain length

| Alkyl Chain Length | Novolac Resin Softening Point (° C.) |
|---|---|
| C₁₆₋₁₈ | 89.8 |
| C₂₀₋₂₄ | 96.8 |
| C₂₄₋₂₈ | 95.0 |
| C₃₀₊ | 78.0 |

FIG. 3A illustrates the unaged tack performance where the tack pull-off force is plotted as a function of the minimum carbon chain length of the long chain alkylphenol monomer in the alkylphenol composition. The plot shows a direct, linear correlation between tack pull-off force and chain length. Also plotted is the tackifier response of SP-1068, shown as a short-dashed line. This comparison shows that a chain length of C₁₆₋₁₈ provides a lower tack response than SP-1068 in the silica tread formulation and is comparable to the blank compound containing no tackifier resin, which is shown as a long-dashed line. At chain lengths of C₂₀₋₂₄, the tackifying resin made from p-cresol, the alkylphenol monomer, and formaldehyde provides a tack response approximately equivalent to the SP-1068 control. At greater than C₂₀₋₂₄ chain length, the unaged tack response becomes higher than that of the control compound, SP-1068, and the blank in the silica tread formulation.

A similar study was conducted for a resin including p-cresol instead of phenol. The general result showed a correlation between an increase in chain length with an increase in tack performance. Samples used in the study are shown below, along with the softening point measured for each novolac resin.

TABLE 6
List of samples included in the study of p-cresol/alkylphenol
monomer tackifier chain length

| Alkyl Chain Length | Novolac Resin Softening Point (° C.) |
|---|---|
| C₂₀₋₂₄ | 93.2 |
| C₂₄₋₂₈ | 86.0 |
| C₃₀₊ | 96.4 |

FIG. 3B illustrates the unaged tack performance where the tack pull-off force is plotted as a function of the minimum carbon chain length of the long chain alkylphenol monomer of the alkylphenol composition. The plot shows a direct, linear correlation between tack pull-off force and chain length. Also plotted is the tackifier response of SP-1068, shown as a short-dashed line. This comparison shows that a chain length of C₁₆₋₁₈ provides a lower tack response than SP-1068 in the silica tread formulation and is comparable to the blank compound containing no tackifier resin, which is shown as a long-dashed line. At chain lengths greater than C₂₀₋₂₄, the tackifying resin made from p-cresol, the alkylphenol monomer, and formaldehyde provides a tack response approximately equivalent to the SP-1068 control. At greater than C₂₀₋₂₄ chain length, the unaged tack response becomes higher than that of the control compound, SP-1068, and the blank in the silica tread formulation.

### Example 4

This example demonstrates the effect on tack performance in a silica tread formulation when incorporating p-sec-butylphenol (PSBP) into the novolac resin with a C₂₄₋₂₈ alkylphenol monomer. The silica tread formulation utilized was as provided in Example 2. For comparison, a sample of SP-1068 was also mixed into the same formulation and a blank compound, containing no tackifier, was included.

FIG. 4 illustrates the unaged tack performance for the three samples. The PSBP/LCAP2428 resin sample provided higher unaged tack than the sample containing SP-1068. SP-1068 was shown to only slightly tackify the silica tread formulation, in agreement with the previous study presented on the SVHC-free tackifier in the same formulation.

### Example 5

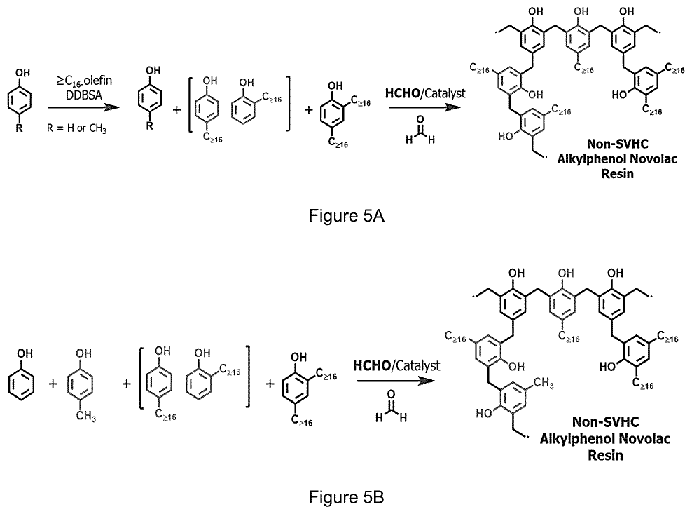

This example demonstrates reaction pathways in preparing an SVHC free novolac resin as described herein. In particular, the pathways are illustrated in FIGS. 5A and 5B.

For instance, FIG. 5A illustrates a pathway that includes alkylation of a phenolic monomer (e.g., phenol or cresol) with an olefin (with a carbon chain length of 16 or greater carbon atoms) in the presence of an acid catalyst to form an alkylphenol composition including an alkylphenol monomer (with an alkyl chain length of 16 or greater carbon atoms) and a phenolic monomer as defined herein. Thereafter, the alkylphenol composition undergoes a subsequent reaction with formaldehyde and a corresponding catalyst for the synthesis of the novolac resin.

In FIG. 5B, an alkylphenol composition including an alkylphenol monomer (with an alkyl chain length of 16 or greater carbon atoms) and a phenolic monomer as defined herein is reacted with formaldehyde and a corresponding catalyst for the synthesis of the novolac resin.

### Example 6

In this example, a linear C₂₄₋₂₈ alpha-olefin side chain chemistry was evaluated in-depth as the long chain alkylphenol (LCAP) monomer and is separated into two different process types, namely, reflux or energetic. In particular, these processes are characterized solely based on the process conditions chosen during the formaldehyde addition step. These two different processes were developed using two separate design spaces, and the factors that were evaluated for each space are highlighted in Table 7 below. The molar ratio of formaldehyde to phenol (e.g., phenolic monomer and/or alkylphenol monomer) (“F2P”) in each subsequent polycondensation with formaldehyde is calculated by ignoring the difference in reaction stoichiometry between the alkylated phenols and unreacted phenol and is strictly the ratio of the sum of moles formaldehyde to sum of moles alkylphenol and phenol in the reaction formulae. In addition to F2P, an F2Rx value as provided below may give an indication as to the ratio of formaldehyde to available reaction sites. As an example, phenol may have three reaction sites, a para substituted monoalkylphenol may have two reaction sites, and an ortho/para substituted dialkylphenol may have one reaction site.

TABLE 7
Reaction conditions and factors for synthesis of novolac resin
REFLUX PROCESS

| Factor 1 | Factor 2 | Factor 3 | |
|---|---|---|---|
| Phenol/Olefin | Olefin | F2P | |
| Molar Ratio | mol. % | molar ratio | |
| 2 | 15 | 0.820 | Min |
| 8 | 30 | 0.830 | Max |

ENERGETIC PROCESS

| Factor 1 | Factor 2 | Factor 3 | |
|---|---|---|---|
| LCAP | F2P | Reaction | |
| mol. % | molar ratio | Temp. (° C.) | |
| 20 | 0.78 | 115 | Min |
| 30 | 0.84 | 125 | Max |

The materials prepared from each process were characterized using the dropping and softening point (DP70) as determined in accordance with ASTM D6090-17. In general, SP-1068 has a DP70 targeted range of 85-95° C. The targeted DP70 from each design space for the novolac resin as disclosed herein was 90-95° C. and the results from each design point are shown in Table 8.

The reflux process is simply a chemical unit operation by which the volatile liquid phase of the reaction is retained within the reaction mass while the reaction reaches a limited internal reaction temperature—with water being the most volatile component in the reaction mass, the internal temperature is thus limited between 95-100° C. Each reflux process example in Table 8 is described by the reaction scheme shown in FIG. 5A where in the first step a C₂₄₋₂₈ alpha-olefin is reacted with phenol under acidic conditions to produce an intermediate product distribution, which is predominantly comprised of unreacted phenol and a mixture of mono- and dialkylated phenols. A portion of the unreacted phenol is later removed by vacuum distillation. Additional phenol is then back-added to this alkylated-phenol concentrate to adjust down to the targeted mol % olefin required in the formula as described for sample numbers 1-28. After adjusting the concentration of monomers, these mixtures are then deployed in a condensation reaction with 37% formaldehyde to prepare the non-SVHC alkylphenol novolac resins, as defined by the design factors in Table 8.

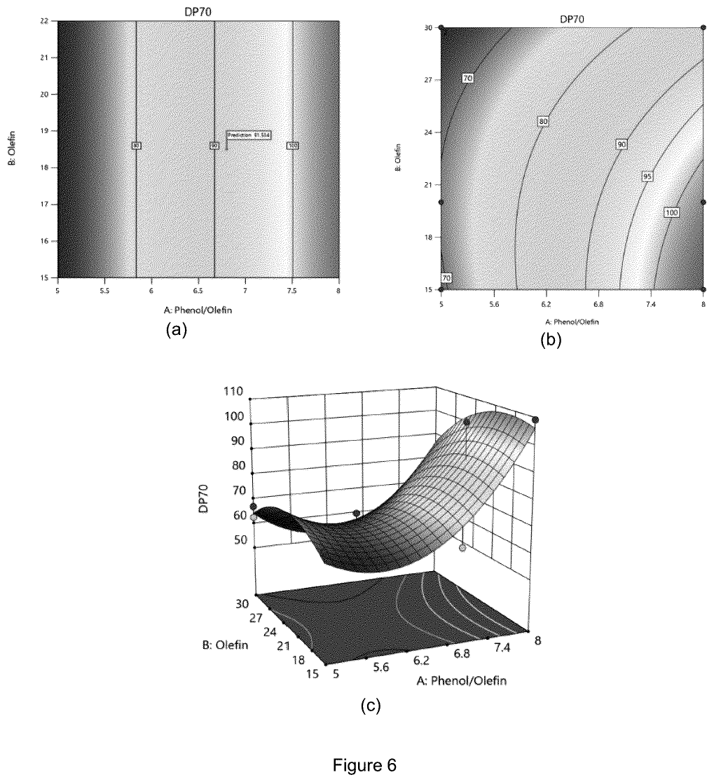

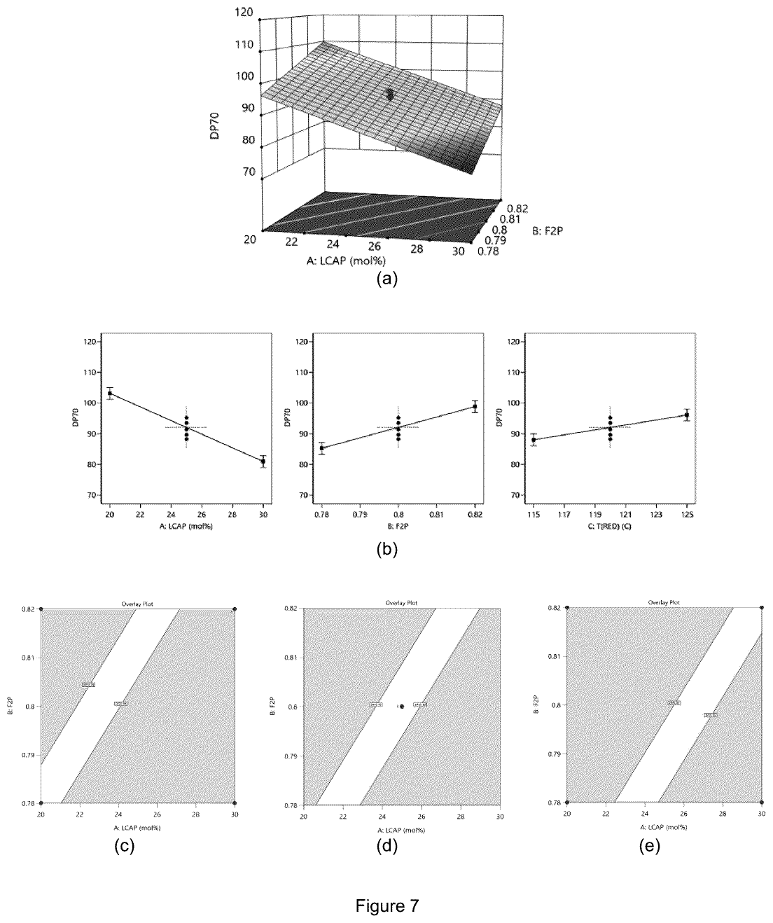

To begin, the products produced in sample numbers 1 and 2 were difficult to process using the reflux process, and because of these challenges the phenol/olefin molar ratio for the design space was adjusted to the range of 5:1 to 8:1. The analysis of sample numbers 5-13 produced a response surface that was flat (FIG. 6) and based on this surface, sample number 16 was anticipated to produce a novolac resin product with a DP70 close to 90-95° C. The DP70 for sample number 16 was outside the desired range and a subsequent series of samples (17-22) was used to probe the curvature of the response surface with the expectation that a sample would converge into the desired range of 90-95° C. as indicated by the heat map charts in FIG. 7. The sequential inclusion of each of these design points plus an expanded mol % of olefin content to reach 30% produced a response surface with significant curvature and steepness resulting in the higher probability of not reliably producing a product with a DP70 in the range of 90-95° C.

To highlight the benefit of deploying an energetic process over a reflux process for these novolac resins, the reflux processed-novolac resin prepared in sample number 16 afforded a novolac resin with a DP70 of 73.1° C., but when an energetic process is deployed (sample numbers 29 and 30), namely, a chemical unit operation that maintains an internal pot set point (115° C.) while adding aqueous formaldehyde at a rate to also maintain the set point of 115° C., afforded novolac resins with a DP70 of 105° C. and 92.0° C., respectively. Sample number 30 incorporates the monomers in such a fashion to achieve the desired DP70 in the range of 90-95° C., but more importantly, this is achieved while requiring less formaldehyde than deployed in sample number 16 suggesting that a more efficient novolac polycondensation reaction is at operation.

One benefit of the energetic process was further developed by evaluating the factors highlighted in the Table 7, but in this case the alkylated-phenol product source was held constant by deploying a commercially available (prepared from linear C₂₄₋₂₈-alpha-olefin) LCAP that was diluted with phenol and subsequently reacted with aqueous formaldehyde at temperatures above the boiling point of water. In this design, additional center points were included in anticipation of model-curvature in the DP70 response surface. Surprisingly the DP70 response for the energetic process was flat (FIG. 7—(a)), and the center points averaged a DP70 of 91.6° C., falling within the desired range of 90-95° C. (FIG. 7—(b)). FIG. 7 ((c)-(e)) also highlight the predicted areas within the error of the modeled experimental design that will afford a novolac resin with a DP70 in the range of 90-95° C. prepared under energetic conditions at reaction temperatures of 115° C., 120° C., and 125° C., respectively.

The energetic process was extended to develop a one-pot two-step chemical process to test the relationship of the molar ratio of phenol-to-olefin when deploying a C₂₄₋₂₈-alpha-olefin in the first step to produce a distribution of alkylated-phenol reaction products that is subsequently condensed with aqueous formaldehyde at 120° C. (Table 9). Recall that this factor was only partially developed for the products developed using the reflux process. Unexpectedly, sample numbers 45 and 46 could not be polymerized to an F2P of 0.800, as these two products-by-process became extremely viscous up to a point deemed processible with only 94% of the desired formaldehyde charge safely delivered to each reaction mixture. At the end point of polymerization, these two novolac resins were characterized by melt points of 116° C. and 108° C. for novolac resins that theoretically contained 20 mol % and 25 mol % of an in-situ LCAP2428. The melt points for these resins differed significantly from the reference center point that deployed a commercially sourced LCAP2428, with an average melt point of 92 (25 mol %, 0.820, 120° C.) Sample numbers 47 and 48 were readily condensed with formaldehyde to F2Ps of 0.800 and 0.790 that afforded melt points of 96° C. and 99° C., respectively. Sample numbers 49 and 50 are derivative experiments of sample number 46, but in these instances the amount of formaldehyde was further reduced to F2Ps of 0.730 and 0.720, which afforded processable resins with melt points of 101° C. and 99° C. respectively.

TABLE 8
Reaction conditions and DP70 values of novolac resins

REFLUX PROCESS

| | Factor 1 | Factor 2 | Factor 3 | |
|---|---|---|---|---|
| | Phenol/Olefin | Olefin | F2P | DP70 |
| No. | Molar Ratio | mol. % | molar ratio | (° C.) |
| 1 | 2 | 15 | 0.83 | 126.3 |
| 2 | 2 | 15 | 0.82 | — |
| 3 | 2 | 20 | 0.83 | 54.4 |
| 4 | 2 | 20 | 0.82 | 54.6 |
| 5 | 5 | 15 | 0.83 | 70.3 |
| 6 | 5 | 15 | 0.82 | 69.0 |
| 7 | 5 | 20 | 0.83 | 71.5 |
| 8 | 5 | 20 | 0.82 | 68.9 |
| 9 | 8 | 15 | 0.83 | 109.2 |
| 10 | 8 | 15 | 0.82 | 105.7 |
| 11 | 8 | 15 | 0.82 | 105.7 |
| 12 | 8 | 20 | 0.83 | 104.5 |
| 13 | 8 | 20 | 0.82 | 104.6 |
| 14 | 5 | 17.5 | 0.825 | 57.8 |
| 15 | 9 | 17.5 | 0.825 | 94.7 |
| 16 | 6.95 | 18.5 | 0.825 | 79.9 |
| 17 | 6.5 | 18.5 | 0.825 | 82.4 |
| 18 | 6.24 | 16 | 0.83 | 62.9 |
| 19 | 6.24 | 25 | 0.83 | 67.2 |
| 20 | 6.95 | 20 | 0.83 | 71.3 |
| 21 | 6.95 | 15 | 0.83 | 65.5 |
| 22 | 7.5 | 20 | 0.83 | 104.9 |
| 23 | 6.5 | 27.5 | 0.825 | 75.8 |
| 24 | 5 | 30 | 0.82 | 63.9 |
| 25 | 5 | 30 | 0.83 | 67 |
| 26 | 5 | 30 | 0.83 | 62.6 |
| 27 | 8 | 30 | 0.82 | 87.9 |
| 28 | 8 | 30 | 0.83 | 83.7 |

ENERGETIC PROCESS

| | | Factor 2 | Factor 3 | |
|---|---|---|---|---|
| | Factor 1 | F2P | Reaction | |
| | LCAP | molar | Temp. | DP70 |
| No. | mol. % | ratio | (° C.) | (° C.) |
| 29 | 20 | 0.85 | 115 | 105 |
| 30 | 20 | 0.810 | 115 | 92.0 |
| 31 | 20 | 0.78 | 115 | 90.5 |
| 32 | 20 | 0.82 | 115 | 105.4 |
| 33 | 20 | 0.78 | 125 | 101.5 |
| 34 | 20 | 0.82 | 125 | 115.2 |
| 35 | 25 | 0.8 | 120 | 89.6 |
| 36 | 25 | 0.8 | 120 | 93.5 |
| 37 | 25 | 0.8 | 120 | 91.4 |
| 38 | 25 | 0.8 | 120 | 88.2 |
| 39 | 25 | 0.8 | 120 | 95.2 |
| 40 | 30 | 0.78 | 115 | 73.5 |
| 41 | 30 | 0.82 | 115 | 82.7 |
| 42 | 30 | 0.82 | 115 | 83.7 |
| 43 | 30 | 0.78 | 125 | 75.6 |
| 44 | 30 | 0.82 | 125 | 92.1 |

TABLE 9
Reaction conditions and DP70 values of one-pot
two-step chemical process
ENERGETIC PROCESS

| | | Factor 2 | Factor 3 | | | |
|---|---|---|---|---|---|---|
| | Factor 1 | In-Situ | F2P | | Reaction | |
| | Phenol/Olefin | LCAP | (molar | F2Rx | Temp. | DP70 |
| No. | (molar ratio) | (mol %) | ratio) | (ratio) | (° C.) | (° C.) |
| 45 | 5 | 20 | 0.750 | 0.536 | 120 | 116 |
| 46 | 4 | 25 | 0.750 | 0.545 | 120 | 108 |
| 47 | 3 | 33 | 0.800 | 0.600 | 120 | 96 |
| 48 | 3 | 33 | 0.790 | 0.592 | 120 | 99 |
| 49 | 4 | 25 | 0.730 | 0.531 | 120 | 101 |
| 50 | 4 | 25 | 0.720 | 0.524 | 120 | 99 |
| 51 | 5 | 20 | 0.710 | 0.507 | 120 | 110 |

### Example 7

In this example, the DP70 of certain novolac resins was determined and the effect was analyzed based on the alkyl chain length.

ENERGETIC PROCESS

| | | | Factor 3 | | |
|---|---|---|---|---|---|
| | Factor 1 | Factor 2 | F2P | Reaction | |
| | LCAP | LCAP | (molar | Temp. | DP70 |
| No. | (type) | (mol %) | ratio) | (° C.) | (° C.) |
| 52 | 16-18 | 25 | 0.8 | 120 | 89 |
| 53 | 20-24 | 25 | 0.8 | 120 | 97 |
| 54 | 24-28 | 25 | 0.8 | 120 | 92 |
| 55 | 30+ | 25 | 0.8 | 120 | 78 |
| 56 | 16-18/20- | 25 | 0.8 | 120 | 102 |
| | 24/24-28/30 + | | | | |
| | (25/25/25/25 | | | | |
| | mol % of each | | | | |
| | alkylphenol | | | | |
| | monomer | | | | |
| | blend) | | | | |

### Example 8

This example illustrates the general process for an acid catalyzed alkylation of a phenol, such as an alkylphenol. In general, the following general procedure was used to alkylate phenol with a C₂₄₋₂₈-alpha-olefin and was adopted to prepare alkylated-phenol mixtures deployed in sample numbers 1-28 and 45-51 in Example 6.

A 5:1 phenol/olefin alkylation mixture was prepared as follows. A tared four neck 3 L round bottom flask equipped with an overhead stirrer, a nitrogen gas inlet, and a condenser was placed in a heating mantle. A nitrogen blanket was applied, and the flask was charged with phenol (1160 g, 12.33 mol) and heated to 70° C. Once at temperature, the reaction mass was charged with DDBSA (63.8, 0.183 mol) followed by the addition of molten C₂₄₋₂₈ alpha-olefin (900 g, 2.47 mol). The reaction was then heated to 160° C. and held for 180 minutes. After holding for three hours, and, depending on the phenol/olefin ratio, the reaction mass was used as-is for subsequent condensation reactions with formaldehyde without further manipulation of this alkylation mixture. For example, sample numbers 1-4 and 45-51 used alkylated phenol mixtures that were not subject to vacuum distillation.

For all other alkylated-phenol reaction mixtures, a portion of phenol was removed by vacuum distillation as follows. In the above 5:1 phenol/olefin reaction mixture, this same four neck round bottom flask was cooled to 120° C. and configured for vacuum distillation. Once at 120° C., vacuum was slowly applied and held at this temperature and pressure (26 inHg) for 2 hours, removing about 476.9 grams of phenol. The amount of phenol removed was determined by reweighing the 4-neck flask and the mass loss was used to determine relative ratios of phenol to alkylated phenols based on the initial charges of phenol and olefin.

### Example 9

This example illustrates the general REFLUX PROCESS for polycondensation of alkylphenol monomers with formaldehyde. In general, continuing with the above alkylation procedure explain in Example 8 for a 5:1 phenol/olefin alkylated phenol reaction product, the following REFLUX PROCESS polycondensation with 37% formaldehyde was performed for sample number 5. To a 500 mL 4-neck flask equipped with an overhead stirrer, a nitrogen gas inlet, an addition funnel, and a condenser was charged 100 g of the 5:1 alkylated phenol-concentrate, which contained approximately 1.53 mmol of alkylated phenol (based on initial charge of C₂₄₋₂₈ olefin) and 2.76 mmol of unreacted phenol. To this mixture was added phenol (30.2 g, 0.321 mol) to adjust the approximate concentration of LCAP to 15 mol %. The 4-neck flask was configured for total reflux return, and an addition funnel was charged with 37% formaldehyde (66.3 g, 0.817 mol) to achieve an approximate F2P of 0.830 and 3 drops of a silicone antifoam agent. The reaction mixture was then heated to 75° C. and once at temperature, 37% formaldehyde was added dropwise over a period of 15 minutes and during the first 5 minutes of addition an increase in temperature to 102° C. was observed. After completing the addition of formaldehyde, the reaction mixture was held at a steady reflux (92° C.) for 30 minutes. The 4-neck flask was then configured for atmospheric distillation and reaction water was removed by distillation by heating the reaction mixture up to 125° C. and holding at this temperature for 30 minutes before neutralizing with DBU (1.83 g, 0.0120 mol). After neutralization, atmospheric distillation was continued up until reaching an internal pot temperature of 140° C. The reaction mixture was held at this temperature for 30 minutes. The 4-neck flask was then configured for vacuum distillation, and the contents in the flask were gradually heated up to 170° C. while slowly applying vacuum to obtain at least 27 inHg. Once at temperature and full vacuum, the reaction mixture was held at this temperature and pressure for 75 minutes after which the vacuum was slowly released, and the molten resin was poured onto a pan to allow to cool to room temperature, affording 149 g of a solid resin with a measured DP70 of 70.3° C.

### Example 10

This example illustrates the general ENERGETIC PROCESS for polycondensation of alkylphenol monomers with formaldehyde. In general, the following procedure was used to prepare polycondensation novolac resins with commercially available LCAPs for sample numbers 31-44 and 52-56 or with in-situ LCAPs for sample numbers 29, 30, and 45-51 of Example 6. To follow is the detailed process for sample number 36 found in Table 8.

A 500 mL four-neck round-bottom flask, equipped with a nitrogen inlet, was charged with LCAP2428 (92.0 g, 0.201 mol), phenol (56.4 g, 0.600 mol), DDBSA (0.420 g, 0.00120 mol), and 3 drops of silicone antifoam and was then configured for active distillation. The mixture was stirred and heated to 120° C. After achieving a stable temperature at 120° C., the 4-neck flask was fitted with an addition funnel that was charged with 37% formaldehyde (52.0 g, 0.640 mol), which was added dropwise over a period of 2-3 hours, with an addition rate adjusted to maintain a consistent temperature of 120° C. under a nitrogen atmosphere to facilitate active distillation. Upon complete addition of formaldehyde, the temperature of the reaction mixture was raised to a holding temperature of 125° C. and maintained for 30 minutes. The batch was then neutralized with DBU (0.200 g, 0.00130 mol) and the temperature was increased to 140° C. and atmospheric distillation was continued. After reaching 140° C., the reaction was configured for vacuum distillation, which was initiated gradually to achieve full vacuum at 140° C. before proceeding to heat the reaction mixture up to 170° C. The reaction mixture was held at 170° C. under full vacuum (30 inHg) and held for 30-60 minutes. Following this, the vacuum was released, and the resin was poured while hot into pans and allowed to cool to room temperature, affording 139 g of a solid resin with a measured DP70 of 93.5° C.

### Example 11

This example demonstrates the application performance using standard rubbers and testing methods in compliance with industry standards and ASTM methodologies noted below.

TABLE 10
ASTM Methods for Rubber Compounding and Testing

| | Method |
|---|---|
| Standard Practice for Rubber-Materials, | ASTM D3182 |
| Equipment, and Procedures for Mixing | |
| Standard Compounds and Preparing | |
| Standard Vulcanized Sheets | |
| Standard Practice for Rubber-Standard | ASTM D1349 |
| Conditions for Testing | |
| MDR | ASTM D5289 |
| Mooney Viscosity | ASTM D1646 |
| Mooney Scorch | ASTM D1647 |
| Payne Effect | ASTM D8059 |
| DMA Strain Sweep (ARES) | based on ASTM D5992 |
| Tensile Properties | ASTM D412, Type C |
| Tensile Aging | ASTM D573 |
| Hardness | ASTM D2240 |

For tack performance, the tack or tackiness of the rubber samples was measured after mixing and milling of the compound according to standard ASTM practices for mixing and milling. The method described below was used to measure unaged tack and tack after 24 and 72 hours of aging. During aging, the samples were conditioned at ambient temperature (approximately 21° C.) and 90% relative humidity. Prior to tack measurement, 330 grams of each sample of filled elastomer were milled at a nip of 80 mils opening with the temperature for the rolls set to 46° C. and 21 rpm for the rear roll on the mill. That material was spread evenly across the rollers and milled for 1 minute to homogenize. The rubber was then sheeted out, and the sheet was laid out flat on a benchtop at room temperature with the milled side facing up for measurement. A Toyoseiki Tackiness Checker HTC-1 handheld tack tester, placed directly on top of the rubber sheet, was used to measure tack across the sheet, gathering 8 individual measurements at each aging period. The tack tester worked by contacting a stainless-steel wheel to the rubber sheet specimen of approximately 3 mm thickness at a force of 12 Newtons for a time of 3 seconds.

Afterwards, the test wheel was raised from the rubber sheet and the force required for the stainless-steel wheel to be separated from the rubber sheet specimen was recorded as the pull off force (tack), in Newtons. The average of the 8 measurements taken was then reported and the deviation in measurements from maximum value and minimum value across the milled sheet was noted.

The data below shows the performance evaluation for sample numbers 4, 5, 8, 11, 14, and 15 of Example 6 (REFLUX PROCESS). All compounding was performed in a Banbury® mixer at an initial rotor speed of 35 rpm and an initial temperature of 80° C. The mixing was used to mix sample numbers 4, 5, 8, 11, 14, and 15 into a 50/50 NR/BR sidewall formulation, based on the sidewall formulation of a passenger car tire, also given below.

TABLE 11
50/50 NR/BR sidewall formulation

| Ingredient | PHR |
|---|---|
| Polybutadiene rubber | 50 |
| Natural rubber | 50 |
| Carbon black 1 | 23 |
| Carbon black 2 | 27 |
| Oil | 7 |
| Stearic acid | 2 |
| Zinc oxide | 3.5 |
| TMQ | 1 |
| Tackifier resin (SP-1068; Sample | 3 |
| number 4, 5, 8, 11, 14, 15) | |
| Antioxidant MDPPD | 1 |
| Antioxidant 6PPD | 3 |
| Microcrystalline wax | 2 |
| Sulfur | 1.5 |
| Accelerator | 0.80 |
| Cyclohexylthiophthalimide (CTP) | 0.27 |

TABLE 12
Select performance properties for sample numbers 4, 5, 8, 11, 14, and 15

| | | | SP- | | | | | | |
|---|---|---|---|---|---|---|---|---|---|
| | | Blank | 1068 | No. 5 | No. 8 | No. 4 | No. 11 | No. 15 | No. 14 |
| ML(1 + 4)100 | [MU] | 52.5 | 47.9 | 51.1 | 52.4 | 50.8 | 50.9 | 52.2 | 51.7 |
| S′ min | [dNm] | 2.1 | 1.9 | 2.1 | 2.2 | 2.1 | 2.1 | 2.1 | 2.1 |
| S′ max | [dNm] | 9.7 | 8.5 | 9.2 | 9.2 | 9.2 | 9.4 | 9.3 | 9.1 |
| S′ max − | [dNm] | 7.6 | 6.6 | 7.0 | 7.1 | 7.1 | 7.3 | 7.2 | 7.0 |
| S′ min | | | | | | | | | |
| Ts2 | [Ts] | 5.1 | 4.6 | 4.8 | 4.7 | 5.1 | 4.7 | 4.9 | 4.9 |
| Tc90 | [Tc] | 9.6 | 8.9 | 9.1 | 9.0 | 9.3 | 8.9 | 8.7 | 9.2 |
| Payne Effect | [kPa] | 362 | 381 | 382 | 432 | 373 | 401 | 401 | 382 |
| (dG′) | | | | | | | | | |
| M100 | [MPa] | 1.3 | 1.2 | 1.3 | 1.2 | 1.3 | 1.2 | 1.2 | 1.2 |
| M300 | [MPa] | 4.6 | 3.8 | 4.0 | 4.0 | 4.1 | 4.1 | 3.9 | 3.8 |
| Stress @ | [MPa] | 19.8 | 18.7 | 18.4 | 18.4 | 18.5 | 18.2 | 18.1 | 17.2 |
| Break | | | | | | | | | |
| Strain @ | [%] | 722 | 795 | 776 | 770 | 760 | 769 | 789 | 796 |
| Break | | | | | | | | | |
| Hardness | [Shore A | 50 | 49 | 49 | 49 | 49 | 49 | 49 | 49 |
| | Durometer] | | | | | | | | |

A selection of properties for the 50/50 NR/BR sidewall formulation with novolac resins from sample numbers 4, 5, 8, 11, 14, and 15 are shown in the table above. Industry standard, SP-1068 phenolic-based tackifier resin was included in the study as a control sample to compare performance against the novel novolac resins. A blank sample was also included in the study for comparative performance against the formulation containing SP-1068 and the example compounds.

The data in the above table shows the tackifiers from the selected examples have nearly identical performance, or minimal differences, versus the control compound SP-1068. This comparison includes Mooney viscosity, crosslink density, scorch, cure time, Payne effect, static tensile properties, and hardness.

In addition, cure curves at 160° C. for SP-1068 and sample numbers 4, 5, 8, 11, 14, and 15 show some slight variation in MH (also given in Table 12) but show a similar state of cure for all materials. The experimental samples, therefore, do not provide a major difference in the cure kinetics or state of cure of the filled rubber when compared to the SP-1068 control sample.

Further, RPA testing of the compounded experimental samples made by the reflux process as well as the blank and SP-1068 control samples were analyzed. Results showed that all experimental samples and the blank material provided higher dynamic stiffness between 0.5-25% strain than the stiffness observed for SP-1068. A range of G″ values was observed for the materials, though in general, the experimental examples provided an increase in the loss modulus. The combination of G′ and G″ characteristics of the materials tested results in higher tangent delta values for all of the tackifiers tested, versus the blank, but experimental sample numbers 4, 5, 8, 11, 14, and 15 provided similar tangent delta values when compared to SP-1068.

In addition, sample numbers 32, 34, 42, and 44, made according to the energetic process, were also studied. All compounding was performed in a Banbury® mixer at an initial rotor speed of 90 rpm and an initial temperature of 60° C. The mixing was based on a silica tread formulation of a passenger car tire. A blank and control resin sample (SP—1068) were also mixed for comparison to the synthetic examples. For samples containing tackifier resin, the phenol-formaldehyde resin was mixed into rubber

TABLE 13
Silica tread formulation for sample numbers 32, 34, 42, and 44

| | | | SP- | | | | |
|---|---|---|---|---|---|---|---|
| | | Blank | 1068 | No. 32 | No. 34 | No. 42 | No. 44 |
| NP1 | Styrene-butadiene rubber | 95.48 | 95.48 | 95.48 | 95.48 | 95.48 | 95.48 |
| | Neodymium butadiene | 25.00 | 25.00 | 25.00 | 25.00 | 25.00 | 25.00 |
| | rubber | | | | | | |
| | Aromatic oil | 11.53 | 11.53 | 11.53 | 11.53 | 11.53 | 11.53 |
| | Silica | 75.00 | 75.00 | 75.00 | 75.00 | 75.00 | 75.00 |
| | Multifunctional silane | 6.00 | 6.00 | 6.00 | 6.00 | 6.00 | 6.00 |
| | coupling agent | | | | | | |
| | NP1 PHR | 213.00 | 213.00 | 213.00 | 213.00 | 213.00 | 213.00 |
| NP2 | NP1 MB | 213.00 | 213.00 | 213.00 | 213.00 | 213.00 | 213.00 |
| | Carbon black | 12.00 | 12.00 | 12.00 | 12.00 | 12.00 | 12.00 |
| | 6PPD | 2.00 | 2.00 | 2.00 | 2.00 | 2.00 | 2.00 |
| | TMQ | 2.00 | 2.00 | 2.00 | 2.00 | 2.00 | 2.00 |
| | Microcrystalline wax | 1.50 | 1.50 | 1.50 | 1.50 | 1.50 | 1.50 |
| | Tackifier resin | | 4.00 | 4.00 | 4.00 | 4.00 | 4.00 |
| | Zinc oxide | 2.50 | 2.50 | 2.50 | 2.50 | 2.50 | 2.50 |
| | Stearic acid | 1.00 | 1.00 | 1.00 | 1.00 | 1.00 | 1.00 |
| | NP2 PHR | 234.00 | 238.00 | 238.00 | 238.00 | 238.00 | 238.00 |
| Prod | NP2 MB | 234.00 | 238.00 | 238.00 | 238.00 | 238.00 | 238.00 |
| Pass | Sulfur (rubber grade) | 1.40 | 1.40 | 1.40 | 1.40 | 1.40 | 1.40 |
| | Accelerator | 1.70 | 1.70 | 1.70 | 1.70 | 1.70 | 1.70 |
| | Diphenylguanidine | 2.00 | 2.00 | 2.00 | 2.00 | 2.00 | 2.00 |
| | Prod Pass PHR | 239.10 | 243.10 | 243.10 | 243.10 | 243.10 | 243.10 |

TABLE 14
Select performance properties for sample numbers 32, 34, 42, and 44

| | | Blank | SP-1068 | No. 32 | No. 34 | No. 42 | No. 44 |
|---|---|---|---|---|---|---|---|
| S′ min | [dNm] | 3.2 | 2.7 | 2.9 | 2.7 | 2.7 | 2.7 |
| S′ max | [dNm] | 18.9 | 16.0 | 16.7 | 16.0 | 15.6 | 15.6 |
| S′ max − | [dNm] | 15.7 | 13.3 | 13.7 | 13.3 | 13.0 | 12.9 |
| S′ min | | | | | | | |
| Ts2 | [Ts] | 1.8 | 2.4 | 1.7 | 1.7 | 1.9 | 1.9 |
| Tc90 | [Tc] | 16.0 | 16.8 | 15.6 | 15.1 | 15.5 | 15.3 |
| dG′ | [kPa] | 725 | 468 | 754 | 758 | 664 | 657 |
| M100 | [MPa] | 2.2 | 2.0 | 2.1 | 2.1 | 2.1 | 2.0 |
| M300 | [MPa] | 10.9 | 9.9 | 10.0 | 10.6 | 10.3 | 9.8 |
| Stress @ | [MPa] | 16.8 | 15.4 | 16.6 | 17.4 | 15.8 | 17.0 |
| Break | | | | | | | |
| Strain @ | [%] | 405 | 407 | 434 | 419 | 398 | 437 |
| Break | | | | | | | |
| Hardness | [Shore A | 65.7 | 63.3 | 66.5 | 65.1 | 64.9 | 64.3 |
| | Durometer] | | | | | | |

A selection of properties for the silica tread formulation with tackifier resins from sample numbers 32, 34, 42, and 44 are shown in the table above. Industry standard SP-1068 phenolic-based tackifier resin was included in the study as a control sample to compare performance against the novel tackifiers. A blank sample was also included in the study for comparative performance against the compound containing SP-1068 and the example compounds.

The data in the above table shows the tackifiers from the selected samples had similar performance as the control compound SP-1068 when tested for crosslink density, tensile stiffness (M100, M300), and strain at break. Scorch (Ts2), cure time (Tc90), stress at break, and hardness showed slight differences between the example compounds and the control sample. The Payne effect (dG′) of the example compounds was shown to be significantly different than the control compound but similar to the blank.

In addition, cure curves at 160° C. for a blank, SP-1068, and sample numbers 32, 34, 42, and 44 showed a similar ML for all samples, but for those samples containing tackifier resin, a MH value lower than the blank compound was observed. The synthetic examples provided similar cure kinetics and state of cure as SP-1068.

Further, RPA testing of the compounded experimental samples made by the energetic process as well as the blank and SP-1068 control samples were analyzed. Results showed that the highest storage modulus sample was the blank, while SP-1068 provided the lowest dynamic stiffness. Experimental samples 32 and 34 provided higher G′ values than samples 42 and 44 which may be attributed to the lower LCAP loading for samples 32 and 34 (20 mol %), while the loading for samples 42 and 44 was 30 mol %. Interestingly, the lower LCAP loading of 20 mol % for samples 32 and 34 provided a higher loss modulus result than was observed for samples 42 and 44. Overall, SP-1068 provided the lowest G″ value of all materials tested, while the blank had one of the highest G″ values observed. In terms of hysteresis, the tangent delta values of samples 32 and 34 (20 mol % LCAP) were higher than that of samples 42 and 44 (30 mol % LCAP), indicating LCAP loading has an effect on rolling resistance and higher amounts of LCAP were favorable. In addition, samples 32, 34, 42, and 44 were shown to possess a higher tan-D than industry standard tackifier SP-1068.

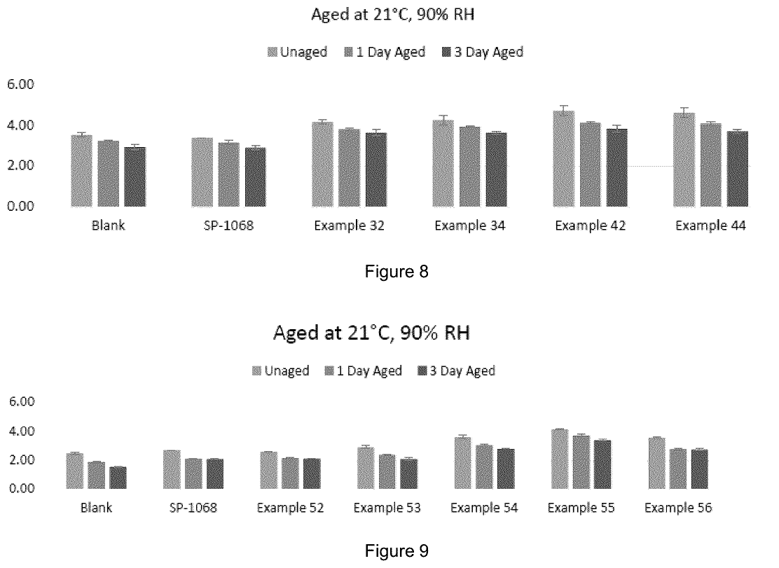

The unaged and aged tack response results are shown in FIG. 8 for the energetic process samples, SP-1068, and the blank compound in the silica tread formulation. The tack response was measured using a Toyoseiki HTC-1 handheld tack tester and reported as the peak force measured. The tack tester works by contacting a stainless-steel probe to an uncured rubber specimen of approximately 3 mm thickness at a force of 12 Newtons for a time of 3 seconds. The probe then separates from the specimen sheet at a speed of 2.3 mm/second. Sample aging was performed at ambient temperature (21° C.) and 90% relative humidity for a period of 1 and 3 days.

Tack testing results indicate equivalent tack performance for SP-1068 and the blank sample in the silica tread formulation. This illustrates that SP-1068 at a loading of 4 phr in this silica tread formulation provides poor ability to provide tack. The experimental samples, however, show an improved tack performance versus the blank and SP-1068, including aged tack response. This shows that at a loading of 20 or 30 mol % LCAP loaded into a phenol-formaldehyde resin chain results in an increased tack response in tread formula containing silica, even after aging at high humidity (90% RH) for a period up to 3 days. Furthermore, it was shown that higher LCAP loading resulted in higher tack response in this rubber formulation.

### Example 12

This example demonstrates the tack performance based on sample numbers 52-56 made according to the energetic process of Example 7.

The data below shows the performance evaluation for synthetic sample numbers 52-56 where the chain length of the long-chain alkyl phenol (LCAP) was studied. The chain lengths of LAP that were studied were 16-18 carbons, 20-24 carbons, 24-28 carbons, and 30+ carbons. In addition, a 25/25/25/25 mol % mixture of 16-18/20-24/24-28/30+ was evaluated for performance. The data is representative of the energetic process described.

All compounding was performed in a Banbury® mixer at an initial rotor speed of 90 rpm and an initial temperature of 60 OC. The mixing was used to mix sample numbers 52-56 in a silica tread formulation of a passenger car tire, given below. A blank and control resin sample (SP-1068) was also mixed for comparison to the synthetic examples. For samples containing tackifier resin, the phenol-formaldehyde resin was mixed into the compound at a loading of 4 phr.

TABLE 15
Silica tread formulation for sample numbers 52-56

| | | | SP- | | | | | |
|---|---|---|---|---|---|---|---|---|
| | | Blank | 1068 | No. 52 | No. 53 | No. 54 | No. 55 | No. 56 |
| NP1 | Styrene-butadiene rubber | 95.48 | 95.48 | 95.48 | 95.48 | 95.48 | 95.48 | 95.48 |
| | Neodymium butadiene | 25.00 | 25.00 | 25.00 | 25.00 | 25.00 | 25.00 | 25.00 |
| | rubber | | | | | | | |
| | Aromatic oil | 11.53 | 11.53 | 11.53 | 11.53 | 11.53 | 11.53 | 11.53 |
| | Silica 1 | 40.00 | 40.00 | 40.00 | 40.00 | 40.00 | 40.00 | 40.00 |
| | Silica 2 | 35.00 | 35.00 | 35.00 | 35.00 | 35.00 | 35.00 | 35.00 |
| | Multifunctional silane | 6.00 | 6.00 | 6.00 | 6.00 | 6.00 | 6.00 | 6.00 |
| | coupling agent | | | | | | | |
| | NP1 PHR | 213.00 | 213.00 | 213.00 | 213.00 | 213.00 | 213.00 | 213.00 |
| NP2 | NP1 MB | 213.00 | 213.00 | 213.00 | 213.00 | 213.00 | 213.00 | 213.00 |
| | Carbon black | 12.00 | 12.00 | 12.00 | 12.00 | 12.00 | 12.00 | 12.00 |
| | 6PPD | 2.00 | 2.00 | 2.00 | 2.00 | 2.00 | 2.00 | 2.00 |
| | TMQ | 2.00 | 2.00 | 2.00 | 2.00 | 2.00 | 2.00 | 2.00 |
| | Microcrystalline wax | 1.50 | 1.50 | 1.50 | 1.50 | 1.50 | 1.50 | 1.50 |
| | Tackifier resin | | 4.00 | 4.00 | 4.00 | 4.00 | 4.00 | 4.00 |
| | Zinc oxide | 2.50 | 2.50 | 2.50 | 2.50 | 2.50 | 2.50 | 2.50 |
| | Stearic acid | 1.00 | 1.00 | 1.00 | 1.00 | 1.00 | 1.00 | 1.00 |
| | NP2 PHR | 234.00 | 238.00 | 238.00 | 238.00 | 238.00 | 238.00 | 238.00 |
| Prod | NP2 MB | 234.00 | 238.00 | 238.00 | 238.00 | 238.00 | 238.00 | 238.00 |
| Pass | Sulfur (rubber grade) | 1.40 | 1.40 | 1.40 | 1.40 | 1.40 | 1.40 | 1.40 |
| | Diphenylguanidine | 2.00 | 2.00 | 2.00 | 2.00 | 2.00 | 2.00 | 2.00 |
| | Accelerator | 1.70 | 1.70 | 1.70 | 1.70 | 1.70 | 1.70 | 1.70 |
| | Prod Pass PHR | 239.10 | 243.10 | 243.10 | 243.10 | 243.10 | 243.10 | 243.10 |

TABLE 16
Select performance properties for sample numbers 52-56

| | | Blank | SP-1068 | No. 52 | No. 53 | No. 54 | No. 55 | No. 56 |
|---|---|---|---|---|---|---|---|---|
| ML(1 + 4)100 | [MU] | 80.4 | 91.3 | 77.1 | 77.8 | 73.9 | 80.8 | 78.4 |
| S′ min | [dNm] | 3.3 | 3.2 | 3.1 | 3.2 | 3.0 | 3.1 | 3.0 |
| S′ max | [dNm] | 16.5 | 15.1 | 15.7 | 15.6 | 15.9 | 15.4 | 15.3 |
| S′ max − | [dNm] | 13.2 | 11.9 | 12.6 | 12.4 | 12.9 | 12.4 | 12.2 |
| S′ min | | | | | | | | |
| Ts2 | [Ts] | 3.0 | 3.3 | 2.5 | 2.6 | 2.9 | 2.6 | 2.8 |
| Tc90 | [Tc] | 14.4 | 14.3 | 14.5 | 14.5 | 16.9 | 14.1 | 14.1 |
| dG′ | [kPa] | 517 | 452 | 736 | 665 | 687 | 516 | 629.4 |
| M100 | [MPa] | 2.5 | 2.2 | 2.3 | 2.3 | 2.1 | 2.4 | 2.6 |
| M300 | [MPa] | 11.4 | 10.3 | 10.2 | 10.3 | 9.3 | 10.6 | 11.2 |
| Stress @ | [MPa] | 13.5 | 15.6 | 15.1 | 14.6 | 16.4 | 15.3 | 15.9 |
| Break | | | | | | | | |
| Strain @ | [%] | 341 | 409 | 405 | 389 | 448 | 396 | 400.3 |
| Break | | | | | | | | |
| Hardness | [Shore A | 63.4 | 63.2 | 65.0 | 65.0 | 65.1 | 64.9 | 66.0 |
| | Durometer] | | | | | | | |

A selection of properties for the silica tread formulation with tackifier resins from synthetic sample numbers 52-56 is shown in the table above. Industry standard SP-1068 phenolic-based tackifier resin was included in the study as a control sample to compare performance against the novel tackifiers. A blank sample was also included in the study for comparative performance against the compound containing SP-1068 and the example compounds.

The data in the above table shows the tackifiers from the selected samples had similar performance as the control SP-1068 when tested for Mooney viscosity, crosslink density, tensile stiffness (M100, M300), stress at break, and strain at break. The hardness showed slight differences between the sample compounds and the control sample. The Payne effect (dG′) of the sample compounds was shown to be significantly different than the control compound, and, in general, appears to decrease with an increase in chain length.

In addition, cure curves at 160° C. for a blank, SP-1068, and sample numbers 52-56 showed a similar ML for all samples, but for those samples containing tackifier resin, a MH value lower than the blank compound was observed. The synthetic examples provided similar cure kinetics and state of cure as SP-1068.

Further, RPA testing of the compounded experimental samples 52, 53, 55, and 56 made by the energetic process as well as the blank and SP-1068 control samples were analyzed. Results showed that LCAP chain length was inversely correlated to storage modulus response of the cured rubber specimens (e.g., lower chain length provided higher G′ and vice versa). This same trend was also observed for the loss modulus response for the samples. Relative to the blank and SP-1068, the sample resins provided higher G′ and higher G″ values. A similar trend was observed for tangent delta of the prepared samples—the blank and SP-1068 provided the lowest tan-D values while, for examples 52, 53, 55, and 56, the lowest chain length LCAP-based resins provided the highest tan-D values, and the longest chain length LCAP-based resins provided the lowest tan-D values. The mixed chain length resin (sample 56) provided a higher tangent delta value versus the blank and SP-1068.

The unaged and aged tack response results are shown in FIG. 9 for the energetic process samples 52-56, SP-1068, and the blank compound in the silica tread formulation. Tack response was measured using a Toyoseiki HTC-1 handheld tack tester and reported as the peak force measured. The tack tester works by contacting a stainless-steel probe to an uncured rubber specimen of approximately 3 mm thickness at a force of 12 Newtons for a time of 3 seconds. The probe then separates from the specimen sheet at a speed of 2.3 mm/second. Sample aging was performed at ambient temperature (21° C.) and 90% relative humidity for a period of 1 and 3 days.

Tack testing results indicate a slight increase in tack performance for SP-1068 versus the blank sample in the silica tread formulation and equivalent performance between SP-1068 and sample number 52 (C16-18 LCAP chain length). Results also showed that an increase in LCAP chain length resulted in an increased tack response. Furthermore, the mixed chain length sample number 56 was made from an equally portioned blend of C16-18/C20-24/C24-28/C30+ LCAPs (25 mol % of each alkylphenol monomer blend) provided the highest tack response for aged and unaged testing.

### Example 13

This example demonstrates the synthesis of a novolac resin as described herein as well as the tack performance of such novolac resin in comparison to a blank and SP-1068.

For the synthesis, a 500 mL four-neck round-bottom flask, equipped with a nitrogen inlet, was charged with LCAP2428 and p-cresol. The mixture was heated to 120° C. Stirring was initiated at 250 rpm using an overhead stirrer equipped with a fixed blade when the mixture was fully melted. At 120° C., 0.0015 equivalent of DDBSA and several drops of silicone antiformal were added. Subsequently, a 37% formaldehyde solution was added dropwise over a period of 2-3 hours, adjusting the rate to maintain a consistent temperature of 120° C. under a nitrogen atmosphere to facilitate active distillation. Upon complete addition of formaldehyde, the reaction mixture's temperature was raised to a holding temperature of 125° C. and maintained for 30 minutes. The batch was then neutralized with DBU and the temperature increased to 140° C. for atmospheric distillation. Vacuum distillation was initiated gradually, achieving full vacuum at 140° C. The reaction mixture was further heated to 170° C. under full vacuum (30 in. Hg) and held for 30-60 minutes. Following this, the system was depressurized, and the resin was transferred into pans and allowed to cool to room temperature. The amounts of the reagents and other reaction and product parameters are shown in Table A.

TABLE 17
Reagent amounts and product parameters for synthesis

| LCAP (mol %) | p-cresol (mol %) | F2P ratio | DP70 (° C.) |
|---|---|---|---|
| 25 | 75 | 0.90 | 98 |

A rubber formulation was prepared utilizing the novolac resin. All compounding was performed in a Banbury® mixer at an initial rotor speed of 75 rpm and an initial temperature of 60° C., using a general mixing procedure to provide a silica tread formulation of a passenger car tire. A blank and control resin sample (SP-1068) were also mixed for comparison to the synthetic examples. For the control resin sample (SP-1068), the phenol-formaldehyde resin was mixed into the compound at a loading of 4 phr. For the exemplary novolac resin, it was mixed at a loading of 2 phr, 4 phr, or 6 phr, respectively.

TABLE 18
Silica tread formulations (loadings in phr)

| | | | | Novolac Resin of |
|---|---|---|---|---|
| | | Blank | SP-1068 | Example |
| NP1 | Styrene-butadiene rubber | 95.48 | 95.48 | 95.48 |
| | Neodymium butadiene | 25.00 | 25.00 | 25.00 |
| | rubber | | | |
| | Aromatic oil | 11.53 | 11.53 | 11.53 |
| | Silica | 75.00 | 75.00 | 75.00 |
| | Multifunctional silane | 6.00 | 6.00 | 6.00 |
| | coupling agent | | | |
| | NP1 PHR | 213.00 | 213.00 | 213.00 |
| NP2 | NP1 MB | 213.00 | 213.00 | 213.00 |
| | Carbon black | 12.00 | 12.00 | 12.00 |
| | 6PPD | 2.00 | 2.00 | 2.00 |
| | TMQ | 2.00 | 2.00 | 2.00 |
| | Microcrystalline wax | 1.50 | 1.50 | 1.50 |
| | SP-1068 | — | 4.00 | — |
| | Example Resin | — | — | 2.0, 4.0, 6.0 |
| | Zinc oxide | 2.50 | 2.50 | 2.50 |
| | Stearic acid | 1.00 | 1.00 | 1.00 |
| | NP2 PHR | 234.00 | 238.00 | 238.00 |
| Prod | NP2 MB | 234.00 | 238.00 | 238.00 |
| Pass | Sulfur (rubber grade) | 1.40 | 1.40 | 1.40 |
| | Diphenylguanidine | 2.00 | 2.00 | 2.00 |
| | Accelerator | 1.70 | 1.70 | 1.70 |
| | Prod Pass PHR | 239.10 | 243.10 | 243.10 |

For each sample, the performance of the rubber composition was determined in compliance with the industry standard ASTM methods as mentioned above. In addition, tack performance was measured after mixing and milling of the composition according to standard ASTM practices for mixing and milling. The method described below was used to measure unaged tack and tack after 24 and 72 hours of aging. During aging, the samples were conditioned at ambient temperature (approximately 21° C.) and 90% relative humidity. Prior to tack measurement, 330 grams of each sample of filled rubber were milled at a nip of 80 mils opening with the temperature for the rolls set to 46° C. and 21 rpm for the rear roll on the mill. That material was spread evenly across the rollers and milled for 1 minute to homogenize. The rubber was then sheeted out, and the sheet was laid out flat on a benchtop at room temperature, with the milled side facing up for measurement. A Toyoseiki Tackiness Checker HTC-1 handheld tack tester, placed directly on top of the rubber sheet, was used to measure tack across the sheet, gathering 8 individual measurements at each aging period. The tack tester worked by contacting a stainless-steel wheel to the rubber sheet specimen of approximately 3 mm thickness at a force of 12 Newtons for a time of 3 seconds. Afterwards, the test wheel was raised from the rubber sheet and the force required for the stainless-steel wheel to be separated from the rubber sheet specimen was recorded as the pull off force (tack), in Newtons. The average of the 8 measurements taken was then reported and the deviation in measurements from maximum value and minimum value across the milled sheet was noted.

Regarding the Mooney viscosity, the following results were obtained: Blank—79.6 MU, SP-1068-80.2 MU, example at 2 phr—79.3 MU, example at 4 phr-78.1 MU, and example at 6 phr—74.7 MU. In general, the data show that increase in phr loading of the exemplary tackifier novolac resin resulted in a decrease in Mooney Viscosity. The exemplary tackifier novolac resin at 2 phr loading provided very similar Mooney Viscosity as control (SP-1068) at 4 phr loading.

Furthermore, the cure profile and crosslink density data show that an increase in phr loading of the exemplary tackifier novolac resin resulted in a decrease in maximum torque (MH) and thus a decrease in crosslink density (MH-ML). For instance, the crosslink density values are as follows: Blank—13.9 dNm, SP-1068-12.8 dNm, example at 2 phr—13.5 dNm, example at 4 phr—12.6 dNm, and example at 6 phr-11.9 dNm.

Also, the results show that the cure times of the exemplary tackifier novolac resin at various loadings were within 1 minute of the control sample. Further, the scorch safety of the exemplary tackifier novolac resin was slightly reduced by about 30-45 seconds compared to the control sample. The change in overall state of cure did not have a significant effect on cure time or scorch safety.

In addition, the physical properties as indicated in Table 19 were also obtained.

TABLE 19
Select physical performance properties

| | | Blank | SP-1068 | 2 phr | 4 phr | 6 phr |
|---|---|---|---|---|---|---|
| M100 (MPa) | unaged | 3.99 | 4.16 | 4.11 | 4.10 | 3.97 |
| M100 (MPa) | aged | 2.0 | 2.0 | 2.1 | 1.9 | 1.8 |
| M300 (MPa) | unaged | 9.9 | 9.5 | 10.0 | 8.9 | 8.2 |
| Strain @ | unaged | 437.2 | 463.7 | 456.7 | 479.3 | 496.4 |
| Break (%) | | | | | | |
| Strain @ | aged | 258.6 | 268.0 | 273.1 | 274.2 | 279.4 |
| Break (%) | | | | | | |
| Hardness | unaged | 63 | 62.9 | 63.6 | 64.1 | 63.2 |
| (Shore A) | | | | | | |
| Hardness | aged | 72 | 72.2 | 73.4 | 73.4 | 73.9 |
| (Shore A) | | | | | | |

For the aged samples, aging was performed for 3 days at 100° C. For unaged samples, an increase in phr loading of the exemplary tackifier novolac resin resulted in a decrease in stress response and an increase in elongation at break. For both the unaged and aged samples, the results of the exemplary tackifier novolac resin at various loadings (2-6 phr) were comparable to the control SP-1068 at 4 phr loading.

In addition, the rheological data showed that the exemplary tackifier novolac resin at 6 phr loading provided high tan-D at low strains. At >2% strain (e.g., 5% strain), tan-D of the exemplary tackifier novolac resin at 4 phr or 6 phr was comparable to the control SP-1068 at 4 phr loading. Tangent delta of the exemplary tackifier novolac resin at 2 phr loading had ˜5% reduction compared to the control SP-1068 at 4 phr loading.

Further, tack performance was also determined. For the aged samples, aging was performed for 24 hours or 3 days at 21° C. and 90% RH (relative humidity). The results show that, overall, the exemplary tackifier novolac resin at various loadings (2-6 phr) provided up to ˜65% better tack than the control SP-1068 at 4 phr loading in silica tread formulation, even after aging. The exemplary tackifier novolac resin provided improved tack over the control SP-1068, even at half the loading (e.g., exemplary novolac resin at 2 phr loading versus SP-1068 at 4 phr loading).

In general, the results indicate that the tack performance of the exemplary tackifier novolac resin was up to 65% higher than the control SP-1068 (which was PTOP-based), dependent on loading. The other properties were about ˜5-10% within the values of the control SP-1068. The high tack performance of the SVHC-free exemplary tackifier novolac resin disclosed herein allows for reduced loadings in tread formulations, resulting in hysteretic improvements.

These and other modifications and variations of the present disclosure may be practiced by those of ordinary skill in the art, without departing from the spirit and scope of the present disclosure. In addition, it should be understood that aspects of the various embodiments may be interchanged both in whole or in part. Furthermore, those of ordinary skill in the art will appreciate that the foregoing description is by way of example only and is not intended to limit the disclosure so further described in such appended claims.

1. A process for preparing a novolac resin, the process comprising:
reacting an alkylphenol composition comprising:
one or more alkylphenol monomers, each of the one or more alkylphenol monomers having one or more alkyl groups of at least 12 carbon atoms, and
one or more phenolic monomers having the following structure (IV) 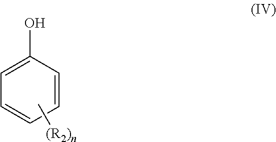
wherein
R₂ is a C₁₋₄ alkyl; and
n is 0, 1, or 2.
with an aldehyde and/or a ketone,
wherein the novolac resin contains 1 wt. % or less of a phenolic compound that is a substance of very high concern based on the weight of the novolac resin.

2. The process of claim 1, wherein the one or more phenolic monomers comprises phenol, cresol, propylphenol, butylphenol, or a mixture thereof.

3. The process of claim 1, wherein the aldehyde and/or the ketone comprises formaldehyde.

4. The process of claim 1, wherein the alkylphenol composition comprises 15-50 mol % of the one or more alkylphenol monomers and 15-80 mol % of the one or more phenolic monomers.

5. The process of claim 1, wherein the alkylphenol composition is prepared by alkylating a phenol with one or more olefins having at least 12 carbon atoms wherein the molar ratio of the phenol to the one or more olefins is 1 or more.

6. The process of claim 5, wherein the process includes a step of removing any unreacted phenol after the alkylating step and prior to reacting with the aldehyde and/or the ketone.

7. The process of claim 1, wherein the molar ratio between the aldehyde and/or the ketone to the combination of the one or more alkylphenol monomers and the one or more phenolic monomers in the alkylphenol composition is from about 0.70 to about 1.5.

8. The process of claim 1, wherein the novolac resin contains 0.5 wt. % or less of the phenolic compound that is a substance of very high concern based on the weight of the novolac resin.

9. The process of claim 1, wherein the process is carried out in the absence of a phenolic compound that is a substance of very high concern.

10. The process of claim 1, wherein the novolac resin contains 1 wt. % or less of resorcinol based on the weight of the novolac resin.

11. The process of claim 1, wherein the process is carried out in the absence of resorcinol.

12. The process of claim 1, wherein the process is carried out in the absence of both a phenolic compound that is a substance of very high concern and resorcinol.

13. The process of claim 1, wherein the phenolic compound that is a substance of very high concern is a para-substituted, tertiary alkylphenol.

14. The process of claim 1, wherein the phenolic compound that is a substance of very high concern is a para-substituted, branched C₄-C₁₂ alkylphenol.

15. The process of claim 1, wherein the phenolic compound that is a substance of very high concern comprises para-tert-butylphenol (PTBP), para-tert-octylphenol (PTOP), para-nonylphenol (PNP) (branched and/or linear), para-dodecylphenol (PDDP), or a mixture thereof.

16. The process of claim 1, wherein the alkyl group in each of the one or more alkylphenol monomers is a linear alkyl group.

17. The process of claim 1, wherein the one or more alkylphenol monomers have one or more alkyl groups ranging from 16 to 28 carbon atoms.

18. A one-pot process for preparing a novolac resin, the process comprising:
alkylating phenol with one or more olefins to form one or more alkylphenol monomers having an alkyl group of at least 12 carbon atoms, wherein the molar ratio of the phenol to the one or more olefins is 1 or more,
providing an alkylphenol composition comprising
the one or more alkylphenol monomers having an alkyl group of at least 12 carbon atoms, and
one or more phenolic monomers having the following structure (IV) 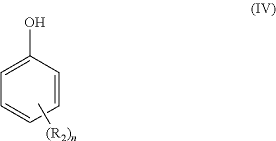
wherein
R₂ is a C₁₋₄ alkyl; and
n is 0, 1, or 2.
reacting the alkylphenol composition with an aldehyde and/or a ketone to form a novolac resin containing 1 wt. % or less of a phenolic compound that is a substance of very high concern based on the weight of the novolac resin,
wherein the alkylating and reacting steps are carried out in one reactor.

19. A novolac resin prepared by the process of claim 1.

20. The novolac resin of claim 19, wherein the novolac resin has a softening point ranging from about 80° C. to 120° C. measured by a dropping point test in accordance with ASTM D6090-17.

21. A rubber composition, comprising:
the novolac resin of claim 19; and
a natural rubber, a synthetic rubber, or a mixture thereof.
